(19) United States
(12) Patent Application Publication
(10) Pub. No.: US 2010/0253958 A1
(43) Pub. Date: Oct. 7, 2010

(54) MEASUREMENT OF OPTICAL TRANSMITTANCE OF PRINTED MATTER

(75) Inventors: Takayoshi Kagata, Shiojiri-shi (JP); Yoshihiko Matsuzawa, Matsumoto-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/753,040

(22) Filed: Apr. 1, 2010

(30) Foreign Application Priority Data
Apr. 3, 2009 (JP) 2009-090746
Jan. 15, 2010 (JP) 2010-006531

(51) Int. Cl. H04N 1/60; G01J 3/46

(52) U.S. Cl. 358/1.9; 356/402

(57) ABSTRACT

A printing method of performing printing on a printed matter by using a printing apparatus is disclosed. The print method includes obtaining from the printed matter a wavelength-based transmittance which is transmittance to plural visible light; determining an optical transmittance of the printed matter based on the wavelength-based transmittance; and ejecting white ink onto the printed matter based on the optical transmittance.

Priority is claimed under 35 U.S.C. §119 to Japanese Application No. 2009-090746 filed on Apr. 3, 2009, and Japanese Application No. 2010-006531 filed on Jan. 15, 2010, which is hereby incorporated by reference in its entirety.

### BACKGROUND

1. Technical Field

The present invention relates to a technology for performing measurement of the optical transmittance of a printed matter.

2. Related Art

There has been known a printing apparatus capable of performing printing by using white ink, as well as color ink such as cyan, magenta or yellow, (e.g., refer to JP-A-2002-38063). The printing apparatus capable of performing printing by using a plurality of colors of ink including white ink can perform a complementary color treatment by using the white ink in accordance with a base treatment or the base color of the print medium, for example, so as to reproduce a color image without being influenced by the base color of the print medium.

For the printed matter of which the white image is formed on the print medium by using the white ink, there is a case in which an appearance of the white image is varied depending upon the optical transmittance of the printed matter, even though a color coordination value (e.g., an L* value) is identical. Conventionally, the optical transmittance of the printed matter is measured by sensitive evaluation of visual appreciation or hazemeter. A technology of measuring the optical transmittance of the printed matter with high accuracy is demanded, in comparison with the conventional measurement using the sensitive evaluation or hazemeter.

Further, such a problem is not limited to the printed matter of which the white image is formed on the print medium by using the white ink, but is a common problem in general printed matters.

### SUMMARY

An advantage of some aspects of the invention is to improve measurement accuracy of the optical transmittance of a printed matter.

In order to solve at least a part of the above problems, the invention can be implemented as aspects or applications below.

### Application 1

A method of measuring the optical transmittance of a printed matter, includes (a) obtaining from the printed matter a wavelength-based transmittance which is the transmittance to each wavelength in a predetermined wavelength range of visible light, and (b) determining the optical transmittance of the printed matter based on the wavelength-based transmittance.

According to the above method, since the wavelength-based transmittance which is transmittance to each wavelength in the predetermined wavelength range of the visible light is obtained from the printed matter, and the optical transmittance of the printed matter is determined based on the wavelength-based transmittance, it is possible to improve measurement accuracy of the optical transmittance of the printed matter, in comparison with conventional measurement using sensitive evaluation of visual appreciation which is varied along different individuals, or a hazemeter with relatively lower sensitivity.

### Application 2

In the method according to Application 1, the step (b) is a step of determining the value obtained by integrating the wavelength-based transmittance in the predetermined wavelength range as the optical transmittance of the printed matter.

According to the method, since the value obtained by not integrating the transmittance of a specific wavelength but integrating the wavelength-based transmittance of each wavelength in the predetermined wavelength range is determined as the optical transmittance of the printed matter, it is possible to improve the measurement accuracy of the optical transmittance of the printed matter.

### Application 3

In the method according to Application 1 or Application 2, the printed matter includes a print medium and an image of a white color which is formed on the print medium, and the predetermined wavelength range is the entire wavelength range of visible light.

According to the method, since the value obtained by integrating the wavelength-based transmittance of each wavelength in the entire wavelength range of visible light is determined as the optical transmittance of the printed matter, it is possible to improve the measurement accuracy of the optical transmittance for the white image of the printed matter which reflects light in the almost the entire wavelength of visible light.

### Application 4

In the method according to any one of Application 1 to Application 3, the step (a) is a step of measuring the reflectance of a substrate having a predetermined optical transmittance, and the reflectance of the printed matter on the substrate, and determining the wavelength-based transmittance based on the optical transmittance and reflectance of the substrate, and the reflectance of the printed matter.

According to the method, since the wavelength-based transmittance of the printed matter is determined based on the optical transmittance and reflectance of the substrate, and the reflectance of the printed matter, without coming directly in contact with a measurement instrument, it is possible to easily measure the optical transmittance of the printed matter and improve the measurement accuracy.

### Application 5

In the method according to the Application 4, the step (a) is a step of determining the product of a square root of the ratio of the reflectance of the printed matter to the reflectance of the substrate, and the optical transmittance of the substrate as the wavelength-based transmittance.

According to the method, it is possible to determine the wavelength-based transmittance based on the optical transmittance and reflectance of the substrate, and the reflectance of the printed matter.

### Application 6

In the method according to Application 4 or Application 5, the step (a) is a step of determining the wavelength-based transmittance of the plurality of substrates having different colors based on the optical transmittance and reflectance of the substrate, and the reflectance of the printed matter, and the step (b) is a step of determining the optical transmittance of the printed matter based the wavelength-based transmittance of the plurality of substrates.

According to the method, since the wavelength-based transmittance of the printed matter is determined based on the optical transmittance and reflectance of the substrate, and the reflectance of the printed matter, without direct measurement by a measurement appliance, it is possible to easily measure the optical transmittance of the printed matter, and to improve the measurement accuracy. Further, according to the method, since the optical transmittance of the printed matter is determined based the wavelength-based transmittance of the plurality of substrates, it is possible to further improve the measurement accuracy of the optical transmittance for the printed matter by controlling the effect of the substrate from the determination of the optical transmittance.

### Application 7

In the method according to Application 6, the step (a) is a step of determining the wavelength-based transmittance of two substrates having different colors based on the optical transmittance and reflectance of the substrate, and the reflectance of the printed matter, and the step (b) is a step of determining the optical transmittance of the printed matter based on the difference between the wavelength-based transmittances of two substrates.

According to the method, since the optical transmittance of the printed matter is determined based on the difference between the wavelength-based transmittances of two substrates, it is possible to further improve the measurement accuracy of the optical transmittance for the printed matter by controlling the effect of the substrate from the determination of the optical transmittance.

### Application 8

In the method according to Application 7, the step (b) is a step of determining the value obtained by integrating the difference between the wavelength-based transmittances in the predetermined wavelength range as the optical transmittance of the printed matter.

According to the method, since the value obtained by integrating the difference between the wavelength-based transmittances in the predetermined wavelength range is determined as the optical transmittance of the printed matter, it is possible to further improve the measurement accuracy of the optical transmittance for the printed matter.

### Application 9

In the method according to any one of Application 1 to Application 8, the method further includes (c) determining whether the color of the printed matter is white or not, based on the determined optical transmittance of the printed matter.

According to the method, since it may be determined whether the color of the printed matter is white or not, based on the determined optical transmittance of the printed matter, it is possible to improve the accuracy in the color judgment of the printed matter.

### Application 10

An apparatus of measuring the optical transmittance of a printed matter includes an acquisition unit of obtaining from the printed matter a wavelength-based transmittance which is transmittance for each wavelength in a predetermined wavelength range of visible light, and a determining unit of determining an optical transmittance of the printed matter based on the wavelength-based transmittance.

### Application 11

A printing apparatus capable of performing printing by using a plurality of colors of ink including a white color includes a determining unit that obtains a wavelength-based transmittance which is the transmittance of each wavelength in a predetermined wavelength range of visible light with respect to a printed matter having a print medium and a white image formed on the print medium, and determines the optical transmittance of the printed matter based on the wavelength-based transmittance; a head having a first nozzle group for ejecting ink onto the print medium to form a color image, and a second nozzle group for ejecting ink of a white color and at least one color except for the white color so as to form a toned white image which is an adjusted white color, on the print medium; and a control unit that identifies the toned white based on the determined optical transmittance and controls the head to form the color image and the toned white image on the print medium.

### Application 12

A printing method capable of performing printing by using a plurality of colors of ink including a white color includes (a) obtaining a wavelength-based transmittance which is the transmittance of each wavelength in a predetermined wavelength range of visible light with respect to a printed matter having a print medium and a white image formed on the print medium, and determining the optical transmittance of the printed matter based on the wavelength-based transmittance; (b) preparing a head having a first nozzle group for ejecting ink onto the print medium to form a color image, and a second nozzle group for ejecting ink of a white color and at least one color except for the white color so as to form a toned white image which is an adjusted white color, on the print medium; and (c) specifying the toned white based on the determined optical transmittance and controlling the head to form the color image and the toned white image on the print medium.

The invention may be implemented as various aspects, and for example, may be implemented in a mode of a measurement apparatus and method, a printing method and apparatus, a printing control method and apparatus, a printing system, a computer program for executing the function of these methods, apparatuses and systems, a recording medium recorded with the computer program, or a data signal including the computer program and realized in a carrier wave.

### BRIEF DESCRIPTION OF THE DRAWINGS

The invention will be described with reference to the accompanying drawings, wherein like numbers reference like elements.

FIG. 1 is a view schematically illustrating the configuration of a printing system according to a first embodiment of the invention.

FIG. 2 is a diagram schematically illustrating the configuration of a PC.

FIG. 3 is a diagram schematically illustrating the configuration of a printer.

FIG. 4 is a block diagram functionally illustrating the configuration of a PC.

FIG. 5 is a block diagram functionally illustrating the configuration of a printer.

FIG. 6 is a flowchart illustrating the flow of a printing process in a printing system according to an embodiment.

FIGS. 7A to 7C are diagrams illustrating an example of a print image, color image data and white image data.

FIGS. 8A and 8B are diagrams illustrating a printing order of a color image and a toned white image.

FIG. 9 is a flowchart illustrating the processing flow of a CPU executing a printer driver.

FIG. 10 is a flowchart illustrating the flow of a toned white designation process.

FIGS. 11A and 11B are diagrams illustrating an example of a UI window for toned white designation.

FIGS. 12A and 12B are diagrams illustrating a color measurement method of a real printer.

FIG. 13 is a flowchart illustrating the flow of a color conversion processing, an ink color separation processing and a halftone processing with respect to a toned white image.

FIGS. 14A and 14B are diagrams partially illustrating an example of a lookup table for a toned white image.

FIG. 15 is a flowchart illustrating the flow of a color conversion processing, an ink color separation processing and a halftone processing with respect to a color image.

FIG. 16 is a diagram partially illustrating an example of a lookup table for a color image.

FIG. 17 is a flowchart illustrating the flow of a command preparation processing.

FIGS. 18A and 18B are diagrams illustrating an example of a command prepared by a command preparation processing.

FIG. 19 is a diagram illustrating an example of the content of an ink code table.

FIG. 20 is a flowchart illustrating the processing flow of a printer.

FIG. 21 is a diagram illustrating the detailed configuration of a raster buffer and a head buffer.

FIGS. 22A to 22C are diagrams illustrating the configuration of a printer head of a printer.

FIGS. 23A and 23B are diagrams illustrating a concept of white toning adjusting a white color.

FIGS. 24A and 24B are diagrams illustrating an example of a color reproduction region (gamut) of a color image and a toned white image.

FIG. 25 is a flowchart illustrating the flow of a color conversion processing, an ink color separation processing and a halftone processing with respect to a toned white image according to a second embodiment.

FIG. 26 is a block diagram functionally illustrating the configuration of a PC according to a third embodiment.

FIG. 27 is a block diagram functionally illustrating the configuration of a PC according to a fourth embodiment.

FIG. 28 is a block diagram functionally illustrating the configuration of a printer according to a fifth embodiment.

FIG. 29 is a flowchart illustrating the flow of a command preparation processing according to a fifth embodiment.

FIG. 30 is a flowchart illustrating the processing flow of a printer according to a fifth embodiment.

FIGS. 31A and 31B are diagrams illustrating a method of storing raster data in a head buffer.

### DESCRIPTION OF EXEMPLARY EMBODIMENTS

Next, the invention will be described in the following order based on embodiments.

### A. First Embodiment

A-1. Configuration of printing system
A-2. Printing process

### B. Second Embodiment

### C. Third Embodiment

### D. Fourth Embodiment

### E. Fifth Embodiment

### F. Modified Example

### A. First Embodiment

### A-1 Configuration of Printing System

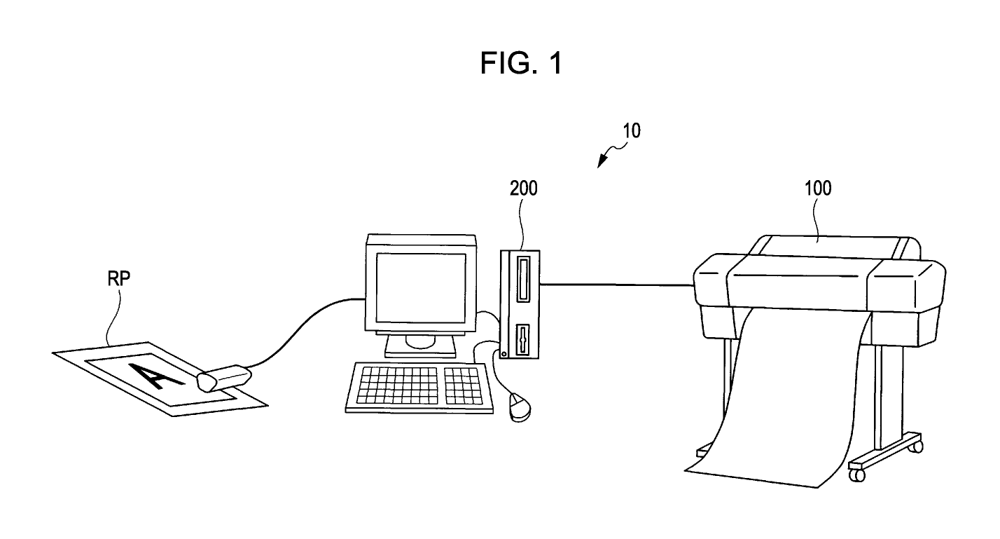

FIG. 1 is a view schematically illustrating the configuration of a printing system according to a first embodiment of the invention. A printing system 10 of this embodiment includes a printer 100 and a personal computer (PC) 200. The printer 100 is a color printer of an ink jet type which prints an image by ejecting ink to form ink dots on a print medium (e.g., printing sheet or transparent film). The PC 200 operates as a printing control unit capable of supplying printing data to the printer 100 and controlling print operation of the printer 100 as a printing control apparatus. The printer 100 and the PC 200 are linked to each other by wired or wireless connections to perform information communication. More specifically, the printer 100 and the PC 200 are connected to each other via a USB cable in this embodiment. In this embodiment, FIG. 1 shows, for example, an actual printed matter (hereinafter, referred to as ‘real print RP’) prepared by printing of a gravure printer.

The printer 100 of this embodiment is a printer capable of performing the printing by using 7 ink colors in total, i.e., cyan (C), magenta (M), yellow (Y), black (K), light cyan (Lc), light magenta (Lm) and white (W). The printing system 10 of this embodiment processes the printing on a transparent film as a print medium in parallel with a color image and a toned white image. The transparent film formed with the color image and the toned white image is used as, for example, a film for commodity packaging.

In this embodiment, adjustment of a white color by blending white ink with ink of other color is referred to as ‘white toning’. Further, the white (adjusted white) generated by the white toning is referred to as ‘toned white’, and an image formed by the toned white is referred to as ‘toned white image’. In addition, the term ‘white color’ means, for example, (1) a color, of which a mark of a Lab system is placed on a circumference having a radius of 20 on the a*b* plane and in the inside of the circumference, and within a hue range L* is represented by 70 or more, if measuring a color by using a colorimeter, eye-one Pro produced by X-Rite Inc. under a colorimetric mode: spot colorimeter, light source: D50, base: Black, and print medium: transparent film, (2) a color, of which a mark of a Lab system is placed on a circumference having a radius of 20 on the a*b* plane and in the inside of the circumference, and within a hue range L* is represented by 70 or more, in a case of measuring a color by using a colorimeter, CM2022 produced by Minolta under a colorimetric mode: D502° field of view, SCF mode, and white base back, and (3) a color of ink used as a background of an image, as disclosed in JP-A-2004-306591. If the white color is used as the background, it is not limited to the pure white color.

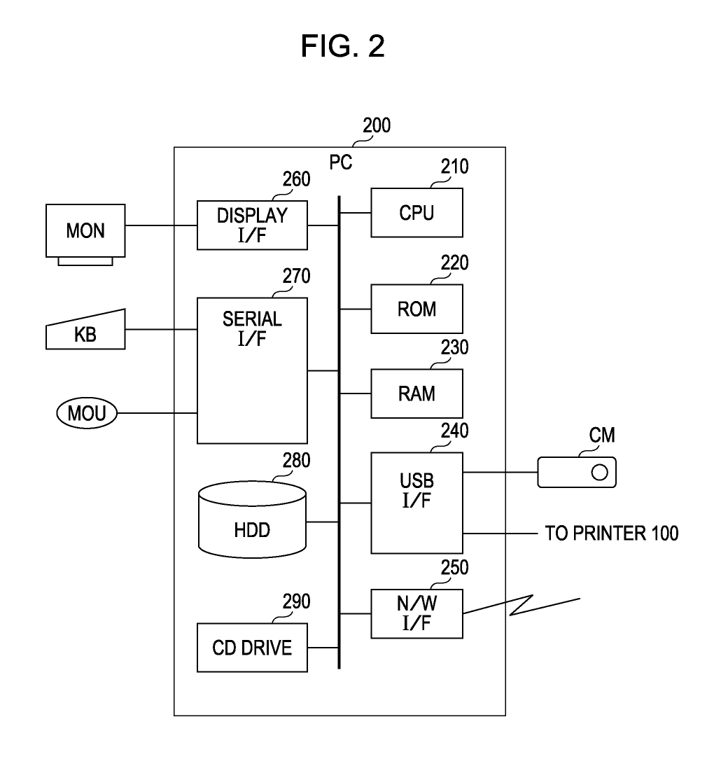

FIG. 2 is a diagram schematically illustrating the configuration of the PC 200. The PC 200 includes a CPU 210, a ROM 220, a RAM 230, a USB interface (USB I/F) 240, a network interface (N/W I/F) 250, a display interface (DISPLAY I/F) 260, a serial interface (SERIAL I/F) 270, a hard disc driver (HDD) 280, and a CD driver 290. Each of the constituent elements of the PC 200 is connected to each other via a bus.

The USB interface 240 of the PC 200 is connected to a colorimeter CM corresponding to the USB interface. The display interface 260 is connected to a monitor MON serving as a display device. The serial interface 270 is connected to a keyboard KB and a mouse MOU which serve as an input device. Further, the configuration of the PC 200 shown in FIG. 2 is just one example, and any constituent element of the PC 200 may be omitted or a new constituent element may be added to the PC 200.

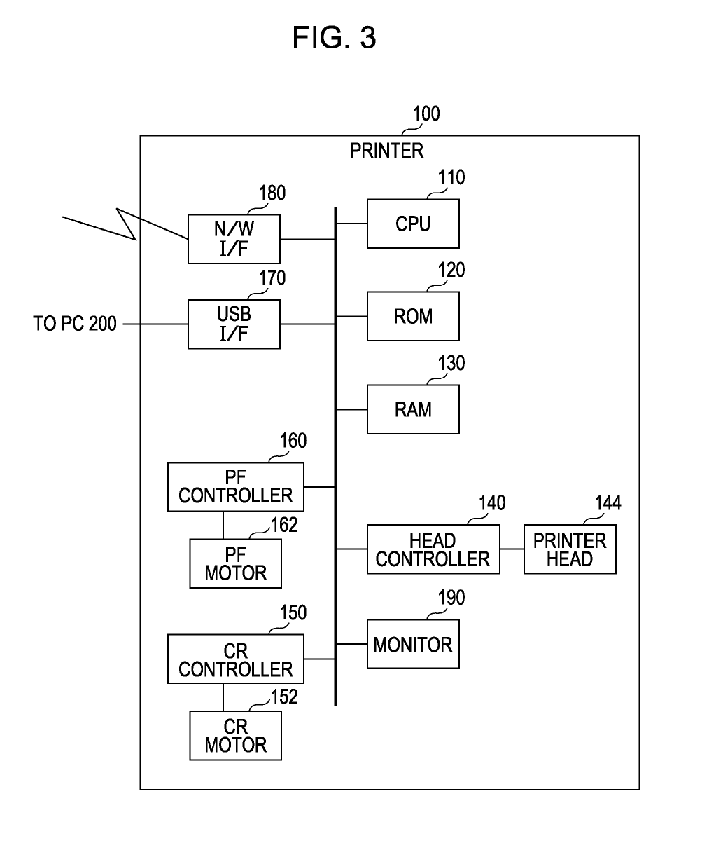

FIG. 3 is a diagram schematically illustrating the configuration of the printer 100. The printer 100 includes a CPU 110, a ROM 120, a RAM 130, a head controller 140, a printer head 144, a carriage controller (CR controller) 150, a carriage motor (CR motor) 152, a print medium transport controller (PF controller) 160, a print medium transport motor (PF motor) 162, a USB interface (USB I/F) 170, a network interface (N/W I/F) 180, and a monitor 190 serving as a display unit. Each of the constituent elements of the printer 100 is connected to each other via a bus.

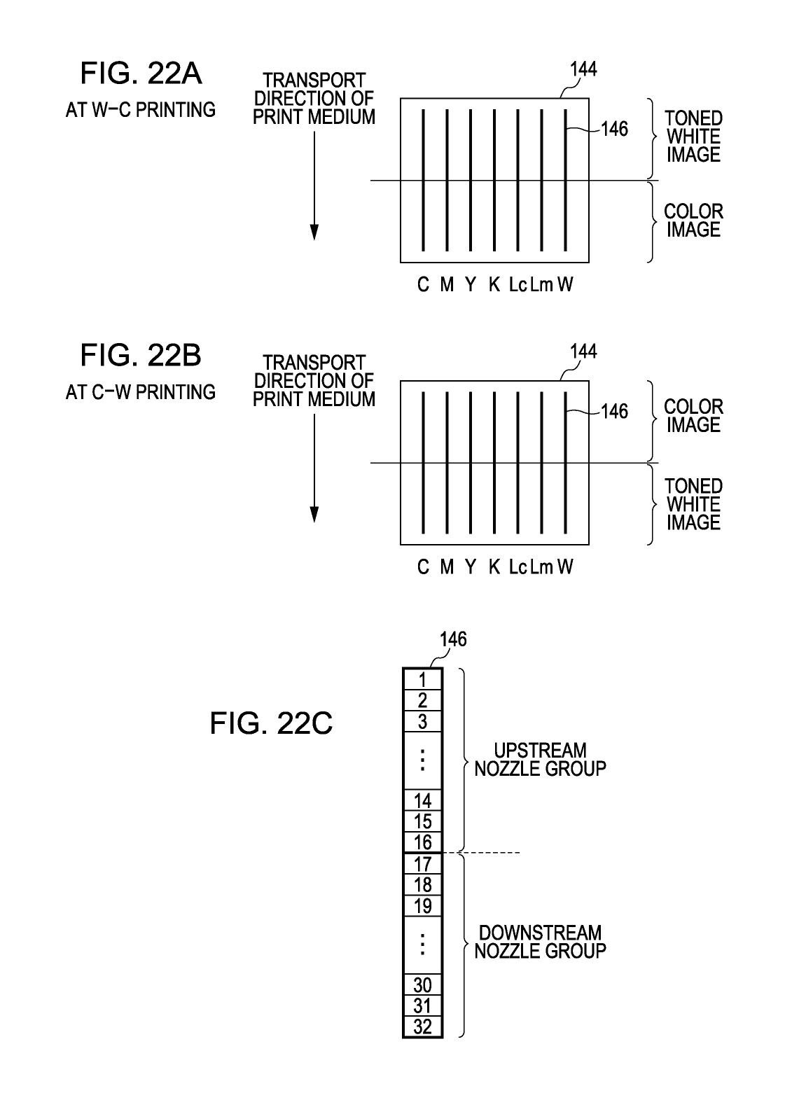

The CPU 110 of the printer 100 serves as control unit to control the whole operation of the printer 100 by executing a computer program stored in the ROM 120. The printer head 144 of the printer 100 is mounted on a carriage which is not shown. The carriage controller 150 controls the carriage motor 152 to reciprocate the carriage in a desired direction. Consequently, main scanning is performed in which the print head 144 reciprocates in a predetermined direction (main scanning direction) of the print medium. Further, the print medium transport controller 160 controls the print medium transport motor 162 to perform a sub scanning in which the print medium is transported in a direction (sub scanning direction) orthogonal to the main scanning direction. The print head 144 has nozzle groups (refer to FIGS. 22A to 22C) for ejecting ink, and the head controller 140 controls the ink ejection from the nozzle groups by the print head 144 in conjunction with the main scanning and the sub scanning As a result, the image is formed on the print medium (printing of image).

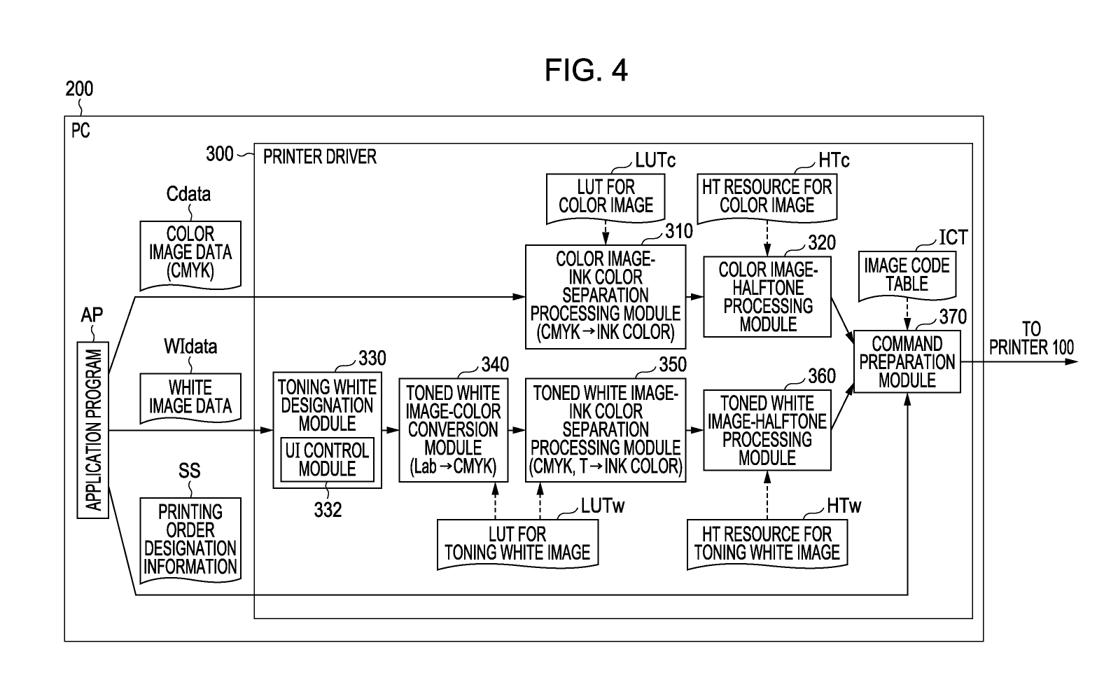

FIG. 4 is a block diagram functionally illustrating the configuration of the PC 200. In the ROM 220 (FIG. 2) of the PC 200, an application program AP and a printer driver 300 are stored as a computer program executed by the CPU 210. The application program AP is a program for performing generation and editing of the image (hereinafter, referred to as ‘print image PI’) which is a target of printing on a transparent film serving as the print medium. The CPU 210 executes the application program AP to perform the generation and editing of the print image PI.

Further, the CPU 210 executing the application program AP outputs color image data Cdata, white image data WIdata, and printing order designation information SS to the printer driver 300 in accordance with a print execution instruction from a user. The content of the respective data will be described in detail in the section of ‘A-2. Printing process’.

The printer driver 300 (FIG. 4) is a program capable of generating printing data (printing command) based on the image data, and controlling the printer 100 (FIG. 1) based on the printing data to perform the printing process of the print image PI. The CPU 210 (FIG. 2) executes the printer driver 300 to perform the printing control of the print image PI by the printer 100.

As shown in FIG. 4, the printer driver 300 includes a color image-ink color separation processing module 310, a color image-halftone processing module 320, a toned white designation module 330, a toned white image-color conversion module 340, a toned white image-ink color separation processing module 350, a toned white image-halftone processing module 360, and a command preparation module 370. The toned white designation module 330 has a UI control module 332. Further, In the HDD 280 (FIG. 2) of the PC 200, a color image-lookup table (LUT) LUTc, a color image-halftone (HT) resource HTc, a toned white image-lookup table (LUT) LUTw, a toned white image-halftone (HT) resource HTw, and an ink code table ICT are stored, and the printer drive 300 and each of the modules execute the processing with reference to the information. The function of the respective modules and the content of each piece of information will be described in detail in the section of ‘A-2. Printing process’.

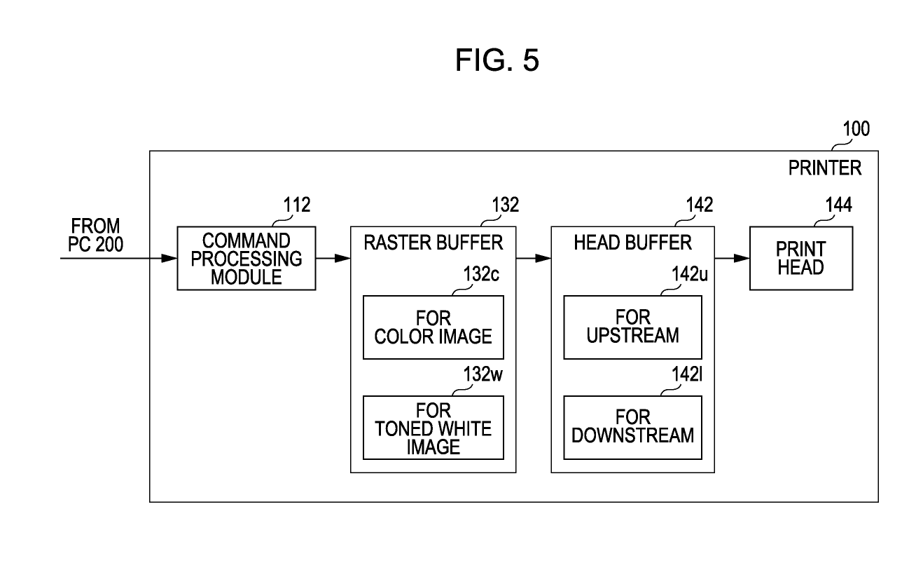

FIG. 5 is a block diagram functionally illustrating the configuration of the printer 100. In the ROM 120 (FIG. 3) of the printer 100, a command processing module 112 serving as a computer program executed by the CPU 110 is stored. As described below, The CPU 110 executes the command processing module 112 to perform the processing of the command received in the PC 200. Further, the RAM 130 (FIG. 3) of the printer 100 has a raster buffer 132. The raster buffer 132 has two regions of a raster buffer 132c for color image and a raster buffer 132w for toned white image. Further, the head controller 140 (FIG. 3) of the printer 100 has a head buffer 142. The head buffer 142 has an upstream head buffer 142u and a downstream head buffer 142l. The functions of these programs or buffers and the detailed configuration thereof will be described in detail in the section of ‘A-2. Printing process’.

### A-2. Printing Process

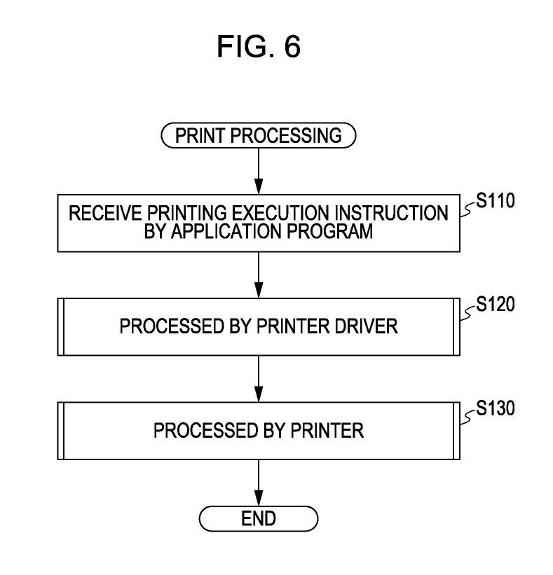

FIG. 6 is a flowchart illustrating the flow of the printing process in the printing system 10 according to this embodiment. The printing process of this embodiment is a process of preparing a printed matter, on which the color image and the toned white image are formed on the transparent film serving as the print medium, in conjunction with the color image and the toned white image.

In step S110 (FIG. 6), the CPU 210 (FIG. 2) executing the application program AP (FIG. 4) receives print execution instruction from the user. The CPU 210 outputs the color image data Cdata, the white image data WIdata, and the printing order designation information SS to the printer driver 300 in accordance with the reception of the print execution instruction (FIG. 4). The color image data Cdata is data specifying the color image in the print image PI, the white image data WIdata is data specifying a white region Aw (described below) in the print image PI, and the printing order designation information SS is data specifying the printing order (described below) of the color image and the toned white image on a portion on which the color image and the toned white image are overlapped.

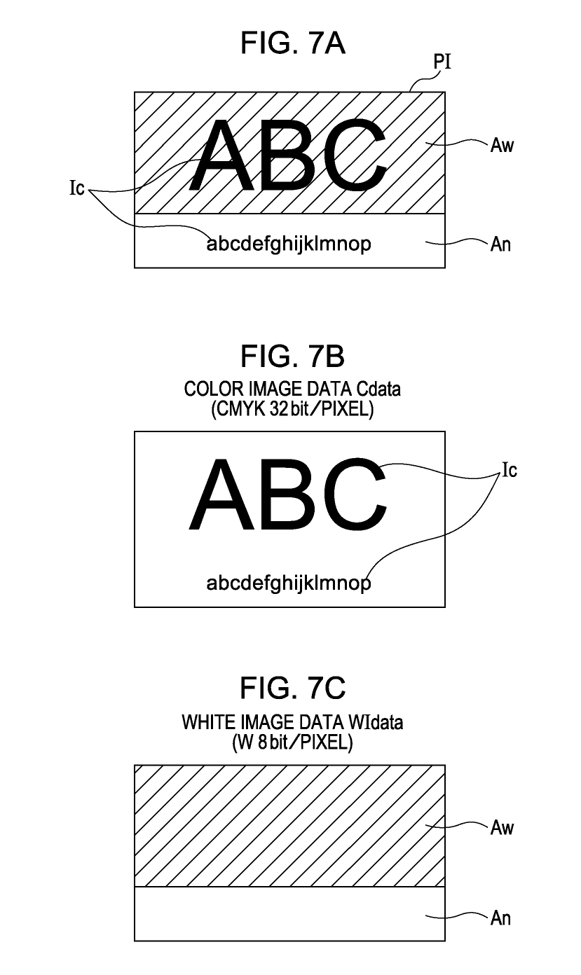

FIGS. 7A to 7C are diagrams illustrating an example of the print image PI, the color image data Cdata and the white image data Widata. FIG. 7A illustrates one example of the print image PI. The print image PI has a color image Ic (an image of ‘ABC’ and an image “abc . . . p’ in the figure). Further, the print image PI consists of a white region Aw and a non-white region An. The white region Aw is a region in which the toned white image is formed, the non-white region An is a region in which the toned white image is not formed. In the example shown in FIG. 7A, in the print image PI, at least a portion of the white region Aw is overlapped with the color image Ic.

FIG. 7B conceptually illustrates the color image data Cdata. In this embodiment, the color image data Cdata is data specifying a color of each pixel of the print image PI as a C value, an M value, a Y value and a K value, each of 8 bits, in a case in which only the color image Ic of the print image PI is noticed. The color image data Cdata becomes data specifying the color of the color image Ic with respect to the pixel corresponding to the color image Ic of the print image PI, and becomes data (e.g., C, M, Y, K=0) displaying that the color image is not formed, with the remaining pixel.

FIG. 7C conceptually illustrates the white image data WIdata. In this embodiment, the white image data WIdata is data specifying the color of each pixel of the print image PI as a W value of 8 bits in a case in which the color image Ic is excluded from the print image PI. Whereby, a value available at the W value is any one of 0 to 255. The white image data WIdata becomes data (e.g., W=255) indicating formation of the toned white image with respect to the pixel corresponding to the white region Aw of the print image PI, and becomes data (e.g., W=0) indicating that the toned white image is not formed, with respect to the remaining pixel (pixel corresponding to the non-white region An). In this instance, the white image data WIdata may be data of 2 bits.

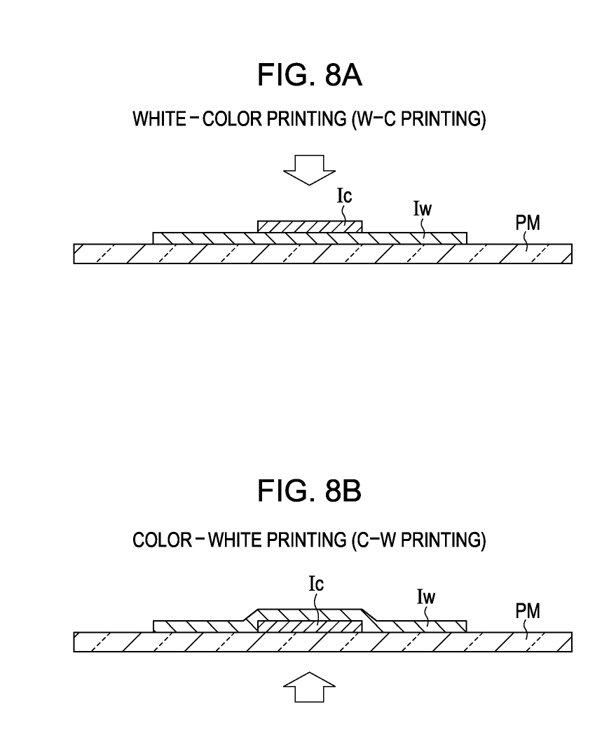

FIGS. 8A and 8B are diagrams illustrating the printing order of the color image and the toned white image. FIG. 8A illustrates the printing order of forming the toned white image Iw on the transparent film serving as the print medium PM and then forming the color image Ic on the toned white image Iw. Herein, the printing order is referred to as ‘white-color printing’ or ‘W-C printing’. In the W-C printing illustrated in FIG. 8A, an observer observes the printed matter from the upward direction of the figure (refer to the arrow in the figure).

FIG. 8B illustrates the printing order of forming the color image Ic on the transparent film serving as the print medium PM and then forming the toned white image Iw on the color image Ic. Herein, the printing order is referred to as ‘color-white printing’ or ‘C-W printing’. In the C-W printing illustrated in FIG. 8B, an observer observes the printed matter from the downward direction of the figure (refer to the arrow in the figure).

The user selects whether the W-C printing is performed or the C-W printing is performed, depending upon a use mode of the printed matter. The CPU 210 executing the application program AP generates the printing order designation information SS specifying the printing order selected by the user to output it to the printer driver 300 (FIG. 4).

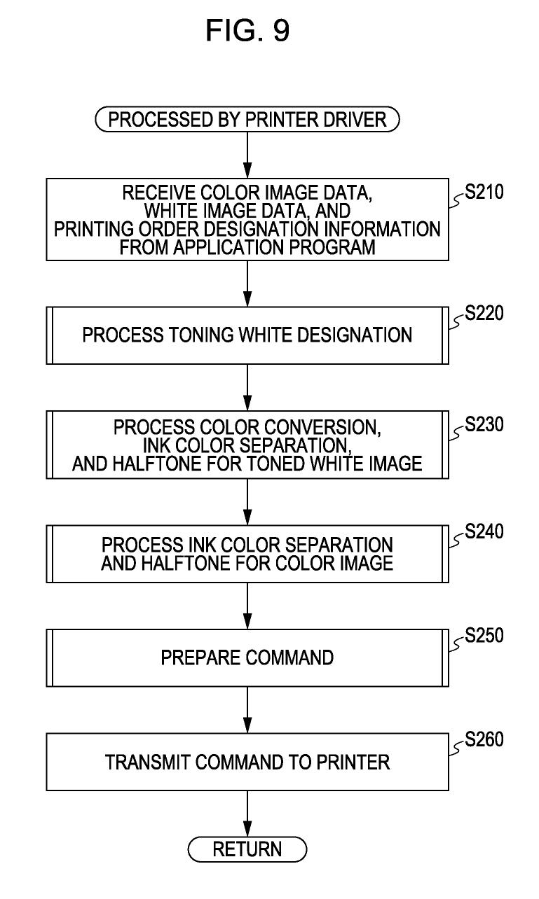

In step S120 of the printing process (FIG. 6), the processing is executed by the CPU 210 executing the printer driver 300 (FIG. 4). FIG. 9 is a flowchart illustrating the processing flow of the CPU 210 executing the printer driver 300. In step S210, the CPU 210 receives the color image data Cdata, the white image data WIdata and the printing order designation information SS output from the application program AP (refer to FIG. 4).

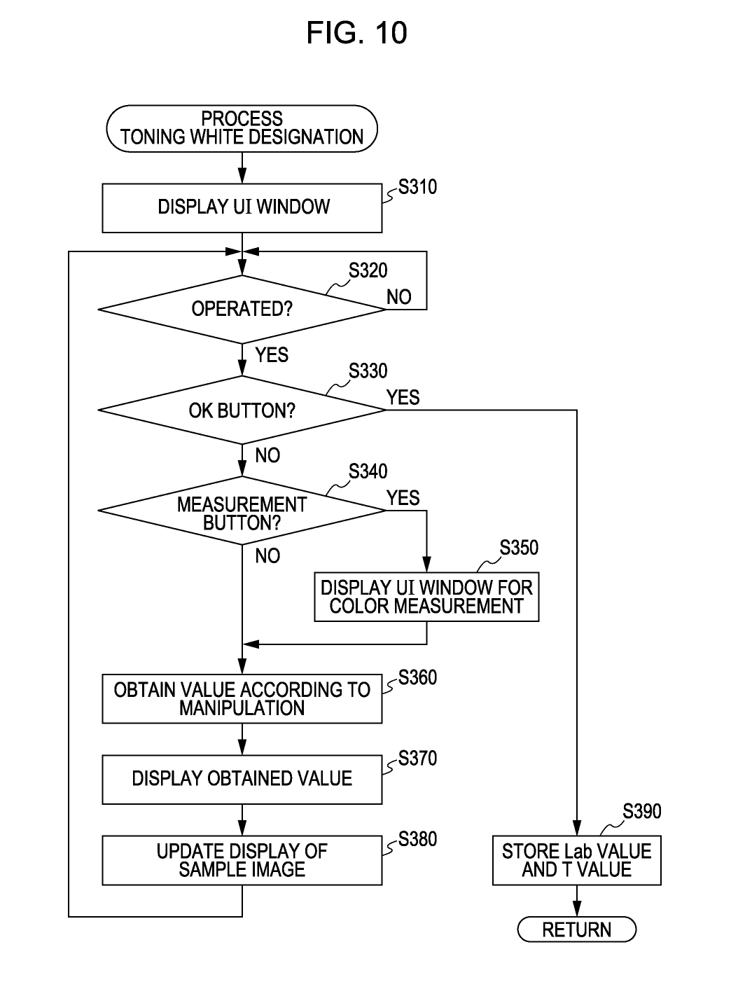

In step S220 (FIG. 9), the toned white designation module 330 (FIG. 4) executes the toned white designation process. The toned white designation process is a process of designating the color of the toned white image corresponding to the white region Aw (refer to FIG. 7A) of the print image PI. FIG. 10 is a flowchart illustrating the flow of the toned white designation process. In step S310, the UI control module 332 (FIG. 4) of the toned white designation module 330 displays a UI window for the toned white designation on the monitor MON (FIG. 2) of the PC 200.

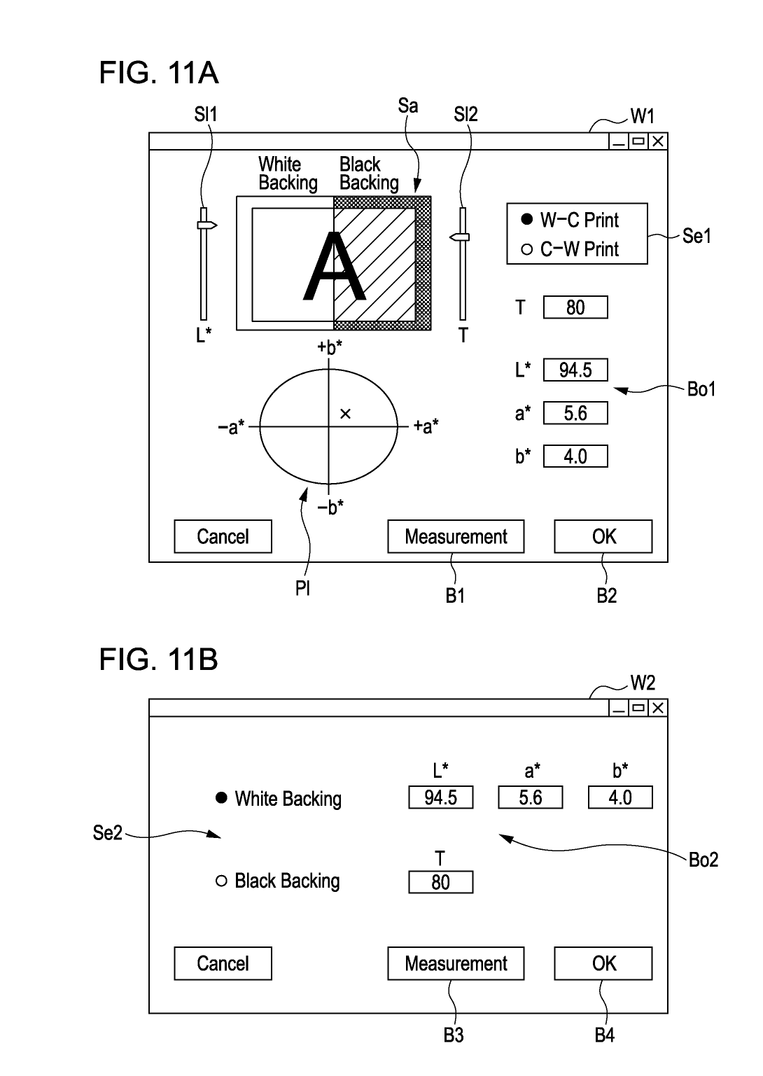

FIGS. 11A and 11B are diagrams illustrating an example of the UI window for the toned white designation. As shown in FIG. 11A, the UI window W1 for the toned white designation is provided with a sample image display area Sa, two slider bars S11 and S12, an ab plane display area P1, a printing order designation box Se1, a value input box Bo1, a measurement button B1, and an OK button B2.

In the UI window W1 for the toned white designation shown in FIG. 11A, the sample image display area Sa is a region for displaying the sample image of the designated toned white. The sample image display area Sa is divided into left and right parts, in which the left is a region (white backing area) indicating a toned white on a white backing, and the right is a region (black backing area) indicating toned white on a black backing In this instance, the outermost region of a sample image display area Sa is a region (base color region) displaying a base color (white or black), and an inside region of the base color region is a region (white image region) displaying the toned white. Further, a color image (image of ‘A’ in the figure) is displayed around the center portion of the sample image display area Sa so as to be stretched over both the white backing area and the black backing area. The color or shape of the color image can be set arbitrarily.

In the UI window W1 for the toned white designation, the value input box Bo1 is a portion for designating the toned white by inputting a color coordination value L* value (hereinafter, referred to simply as ‘L value’), a* value (hereinafter, referred to simply as ‘a value’), b* value (hereinafter, referred to simply as ‘b value’), and T value in an L*a*b* color coordinate system. The L value is a value indicating brightness of the toning color, and is correlated with a quantity of the black (K) ink when the toned white image is printed. The a value and the b value are values indicating chromaticity along a red-green axis and a yellow-blue axis of the toned white. The T value is a value indicating the concentration, and is correlated with a quantity of the ink per unit area when the toned white image is printed. That is, the T value is correlated with a rate of permeability.

In the UI window W1 for the toned white designation, the slider bars S11 and S12 and the ab plane display area P1 are also portions for designating the toned white by inputting the Lab value and the T value.

In the UI window W1 for the toned white designation, the printing order designation box Se1 is a portion for displaying the designation of the above-described printing order. The printing order is set in the application program AP, and the printing order designation information SS specifying the printing order is output from the application program AP to the printer driver 300 (refer to FIG. 4). The printing order designation box Se1 is displayed with whether the printing order identified by the printing order designation information SS is W-C printing or C-W printing. In this instance, in the UI window W1 for the toned white designation, change (designation of new printing order) of the printing order displayed on the printing order designation box Se1 may be designated.

Further, when the UI window W1 for the toned white designation is first displayed, the display state, such as the value input box Bo1 or the sample image display area Sa, becomes a display state corresponding to toned white of a default. For example, the state of the default is a display state corresponding to the previously set Lab value and T value as the color of the white ink of the printer 100.

The UI control module 332 (FIG. 4) monitors whether the keyboard KB or the mouse MOU (FIG. 2) is operated by the user when the UI window W1 for the toned white designation is displayed (step S320 in FIG. 10). In a case where it is judged that it is operated (Yes in step S320) and the operation is neither an OK button B2 nor a measurement button B1 (No in step S330 and No in step S340), the UI control module 332 obtains a value corresponding to the operation (step S360), displays the obtained value in the value input box Bo1 (step S370), and updates the display of the sample image display area Sa (step S380).

For example, if the user selects the value input box Bo1 and simultaneously inputs the value through the keyboard KB (FIG. 2), the input value is displayed in the value input box Bo1, and the color of the sample image display area Sa is changed as the color (toned white) specified by the input value. If the user changes the a value or the b value in the value input box Bo1, the tinge of the color (toned white) of the white image region of the sample image display area Sa is changed. Further, if the user changes the L value of the value input box Bo1, the brightness of the color of the white image region of the sample image display area Sa is changed. If the user changes the T value of the value input box Bo1, since transmittance of the base color is changed, the brightness of the white image region in the black backing area of the sample image display area Sa is changed, but the color of the white image region in the white backing area is not changed. For this reason, since it is possible to easily verify the change of the color corresponding to the change of the T value (concentration value) by comparing the black backing area and the white backing area in the sample image display area Sa, the user can more accurately and easily designate the toned white.

For example, if the user operates the mouse MOU (FIG. 2) to change the position of the slider bar S11, the L value corresponding to the position is obtained, so that the color of the sample image display area Sa is changed as the color specified by the obtained value. Simultaneously, if the user operates the mouse MOU to change the position of the slider bar S12, the T value corresponding to the position is obtained, so that the color of the sample image display area Sa is changed. Further, if the user operates the mouse MOU to change the position of the designation point (displayed as X in the figure) of the ab plane display area P1, the a value and the b value corresponding to the position X are obtained, so that the color of the sample image display area Sa is changed.

In this instance, the input box Bo1, the slider bars S11 and S12, and the ab plane display area P1 are in conjunction with each other. That is, in a case where the value in the value input box Bo1 is changed, the position of the slider bars S11 and S12 or the position X in the ab plane display area P1 is changed. Similarly, in a case where the position of the slider bars S11 and S12 or the position X in the ab plane display area P1 is changed, the changed designation value is displayed in the value input box Bo1.

In this embodiment, the value (Lab value and the T value) specifying the toned white may be designated based on the colorimetric measurement result of the real printer RP (refer to FIG. 1). It is possible to perform the printing process which faithfully reproduces the color of the white portion of the real print RP, by designating the toned white based on the colorimetric measurement result of the real print RP.

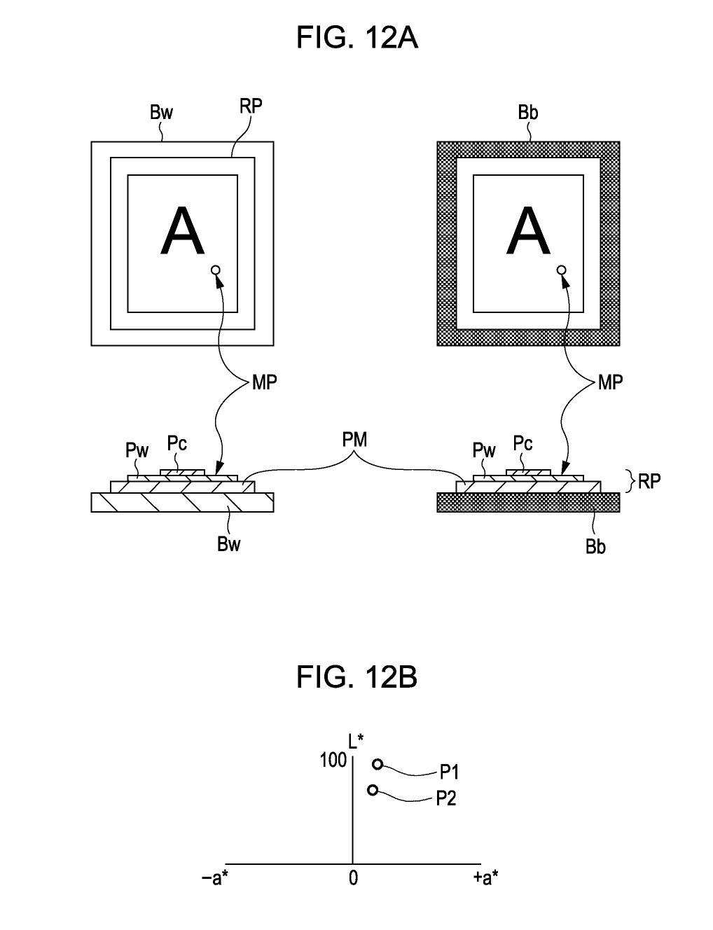

FIGS. 12A and 12B are diagrams illustrating the color measurement method of the real printer RP. The real print RP is a printing record formed with the image (white image) the white portion Pw and the image (color image) of the color portion Pc on the print medium PM. As shown in FIG. 12A, the color measurement is performed by measuring the color coordination value or the like on a measurement point MP by the colorimeter CM (FIG. 2).

In this embodiment, the L value, the a value, and the b value among the values specifying the toned white can be measured by a photoelectric colorimeter as the colorimeter CM. In this instance, the measurement value (L value, a value, and b value) can be changed in accordance with the color of the base (backing) at the time of measurement. For example, in the white-backing color measurement which is performed in a state in which the real print RP is laid on the white substrate Bw, and in the black base color measurement which is performed in a state in which the real print RP is laid on the black substrate Bb, as shown in FIG. 12A, the measurement value (e.g., the L value) may be different, as shown in FIG. 12B. Accordingly, the measurement value is specified as a value in the measurement using any substrate (backing) color. In this embodiment, the L value, the a value, and the b value are used as a measurement value in the white-backing color measurement.

In this embodiment, the T value among the values specifying the toned white can be calculated based on the total optical transmittance S in the white portion Pw of the real print RP is measured by using any one of the first method to the third method below. In this instance, the term ‘measurement’ herein means that the magnitude of a given quantity is indirectly determined through a theory, as well as directly irradiating the magnitude of a given quantity by using an apparatus or a machine.

The first measurement method of the total optical transmittance S in the white portion Pw of the real print RP is as follows. In the first measurement method, the transmittance Tn (wavelength-based transmittance) of the white portion Pw of the real print RP is measured with respect to each wavelength in the entire wavelength range of visible light by a spectral photometer as the colorimeter CM (FIG. 2). In this instance, the entire wavelength range of the visible light is set to 380 to 780 nm. Further, the transmittance Tn is measured with respect to each wavelength at an interval of 1 nm, and the value becomes a value (unit is %) of a range of 0 to 100. A value obtained by integrating the transmittance Tn in the entire wavelength range of the visible light is determined as the total optical transmittance S (hereinafter, referred to as ‘total optical transmittance S1’). That is, the total optical transmittance S1 is calculated by Equation 1 below.

$$\begin{matrix}Equation 1 & \\ {S}_{1} = {\int }_{380}^{780} Tn \cdot d n & ( 1 )\end{matrix}$$

The first measurement method of the total optical transmittance S can improve the measurement accuracy of the optical transmittance S, in comparison with the measurement using sensitive evaluation of visual appreciation which is varied along different individuals, or a hazemeter with relatively lower sensitivity. Further, in the first measurement method of the total optical transmittance S, since the value obtained by not integrating the transmittance of a specific wavelength but integrating the wavelength-based transmittance Tn of each wavelength is determined as the total optical transmittance S, the total optical transmittance can be calculated with respect to the white portion Pw of the real print RP reflecting the light in the overall wavelengths of visible light.

The second measurement method of the total optical transmittance S for the white portion Pw of the real print RP is as follows. In the second measurement method, the transmittance Tn for the white portion Pw of the real print RP is determined, for example, based on the reflectance which is not directly measured by the spectral photometer but measured by a reflective colorimeter as the colorimeter CM. The transmittance Tn is calculated by Equation 2 below. In Equation 2, Rn is the reflectance in the white portion Pw of the real print RP which is measured by the colorimeter CM, Rgn is the reflectance of the substrate (the white substrate Bw or the black substrate Bb in FIG. 12A) measured by the colorimeter CM, and Tgn is transmittance of the substrate in each wavelength of the visible light which is previously measured by the spectral photometer. That is, the transmittance Tn of the white portion Pw of the real print RP is calculated by a product of a square root of a ratio of the reflectance Rn of the white portion Pw of the real print RP to the reflectance Rgn of the substrate, and the transmittance Tgn of the substrate. In this embodiment, the transmittance Tgn of the substrate is previously measured with respect to the two substrates of the white substrate Bw and the black substrate Bb, and then is stored in the HDD 280 (FIG. 2) of the PC 200.

$$\begin{matrix}Equation 2 & \\ Tn = \sqrt{\frac{Rn}{Rgn}} Tgn & ( 2 )\end{matrix}$$

In the second measurement method, the value obtained by integrating the calculated transmittance Tn in the entire wavelength range of the visible light is determined as the total optical transmittance S (hereinafter, referred to as ‘total optical transmittance S2 ’), similar to the above-described first measurement method. That is, the total optical transmittance S2 is calculated by Equation 3 below.

$$\begin{matrix}Equation 3 & \\ {S}_{2} = {\int }_{380}^{780} Tn \cdot d n & ( 3 )\end{matrix}$$

The second measurement method of the total optical transmittance S does not use the spectral photometer which is an expensive and extensive colorimeter, and can improve the measurement accuracy of the total optical transmittance S in comparison with the measurement using the sensitive evaluation or the hazemeter. Further, according to the second measurement method of the total optical transmittance S, since the value obtained by not integrating the transmittance of a specific wavelength but integrating the transmittance Tn of each wavelength is determined as the total optical transmittance S, it is possible to calculate the total optical transmittance with high accuracy with respect to the white portion Pw of the real print RP reflecting the light in almost all wavelengths of visible light.

The third measurement method of the total optical transmittance S for the white portion Pw of the real print RP is as follows. In the third measurement method, the transmittance Tn for the white portion Pw of the real print RP is determined, for example, based on the reflectance which is not directly measured by the spectral photometer but measured by the reflective colorimeter as the colorimeter CM. Further, determination of the transmittance Tn is performed on two cases in which the real print RP is laid on two substrates of different color. In this instance, it is preferable that two substrates are combined to make transmittance (reflectance) difference large. In this embodiment, the white substrate Bw and the black substrate Bb are used. That is, the transmittance Tn(Tan) of the white portion Pw of the real print RP laid on the white substrate Bw is calculated by using Equation 4 below, and the transmittance Tn(Tbn) of the white portion Pw of the real print RP laid on the black substrate Bb is calculated by using Equation 5 below. In Equation 4, Ran is the reflectance of the white portion Pw of the real print RP laid on the white substrate Bw which is measured by the colorimeter CM, Ragn is the reflectance of the white substrate Bw measured by the colorimeter CM, and Tagn is the transmittance of the white substrate Bw in each wavelength of the visible light which is previously measured by the spectral photometer. That is, the transmittance Tn (Tan) of the white portion Pw of the real print RP laid on the white substrate Bw is calculated by a product of a square root of the ratio of the reflectance Ran of the white portion Pw of the real print RP to the reflectance Ragn of the white substrate Bw, and the transmittance Tagn of the white substrate Bw. In Equation 5, Rbn is a reflectance of the white portion Pw of the real print RP laid on the black substrate Bb which is measured by the colorimeter CM, Rbgn is a reflectance of the black substrate Bb measured by the colorimeter CM, and Tbgn is the transmittance of the black substrate Bb in each wavelength of the visible light which is previously measured by the spectral photometer. That is, the transmittance Tn (Tbn) of the white portion Pw of the real print RP laid on the black substrate Bb is calculated by a product of a square root of the ratio of the reflectance Rbn of the white portion Pw of the real print RP to the reflectance Rbgn of the black substrate Bb, and the transmittance Tbgn of the black substrate Bb.

$$\begin{matrix}Equation 4 & \\ Tan = \sqrt{\frac{Ran}{Ragn}} Tagn & ( 4 ) \\ Equation 5 & \\ Tbn = \sqrt{\frac{Rbn}{Rbgn}} Tbgn & ( 5 )\end{matrix}$$

In the third measurement method, the effect of the substrate (the color of the substrate) is excluded from the calculation of the total optical transmittance S by obtaining the difference between the transmittances Tn (the transmittance Tan and Tbn) calculated from two substrates. Further, in the third measurement method, the value obtained by integrating the calculated transmittance Tn in the entire wavelength range of the visible light is determined as the total optical transmittance S (hereinafter, referred to as ‘total optical transmittance S3’), similar to the above-described first measurement method. That is, the total optical transmittance S3 is calculated by Equation 6 below.

$$\begin{matrix}Equation 6 & \\ {S}_{3} = {\int }_{380}^{780} ( Tan - Tbn ) \cdot d n & ( 6 )\end{matrix}$$

The third measurement method of the total optical transmittance S does not use a spectral photometer, which is an expensive and extensive colorimeter, can improve the measurement accuracy of the total optical transmittance S in comparison with the measurement using the sensitive evaluation or the hazemeter. Further, in the third measurement method of the total optical transmittance S, the effect of the substrate (the color of the substrate) is excluded from the calculation of the total optical transmittance S by obtaining the difference between the transmittances Tn calculated from two substrates, thereby further improving the measurement accuracy of the total optical transmittance S. Further, according to the third measurement method of the total optical transmittance S, since the value obtained by not integrating the transmittance of a specific wavelength but integrating the transmittance Tn of each wavelength is determined as the total optical transmittance S, it is possible to calculate the total optical transmittance with high accuracy with respect to the white portion Pw of the real print RP reflecting the light in almost all wavelengths of the visible light.

In this embodiment, it is possible to calculate the T value among the values specifying the toned white by performing the conversion which is previously set on the total optical transmittance S in the white portion Pw of the real print RP calculated by using any one of the first method to the third method as described above. In this embodiment, the T value is calculated by converting (normalizing) an inverse number of the total optical transmittance S into a value in a range of 0 to 100. Consequently, it is possible to perform the printing process which faithfully reproduces the total optical transmittance S of the real print RP.

In a case where it is judged in step S320 of FIG. 10 that operation is performed (Yes in step S320) and it is judged that the operation is performed not on the OK button B2 (No in step S330) but on the measurement button B1 (Yes in step S340), the UI control module 332 (FIG. 4) displays the UI window W2 for color measurement shown in FIG. 11B on the monitor MON (FIG. 2) of the PC 200 (step S350).

The UI window W2 for color measurement (FIG. 11B) is a UI window for designating the value specifying the toned white by the color measurement of the real print RP. The UI window W2 for color measurement is provided with a background selection area Se2, a colorimetric value display box Bo2, a measurement button B3, and an OK button B4. The background selection area Se2 is a portion for selecting either white-backing color measurement or black base color measurement to be performed. The user selects the colorimetric method in the background selection area Se2 and simultaneously selects the measurement button B3, thereby performing the color measurement according to the selected method.

As described above, the colorimetric value in the white-backing color measurement is used as the L value, the a value and the b value specifying the toned white in this embodiment. Accordingly, in a case of designating the L value, the a value and the b value by the color measurement, the user selects the white-backing color measurement in the background selection area Se2 of the UI window W2 for colorimetery and simultaneously selects the measurement button B3, thereby performing the white-backing color measurement (refer to the right figure in FIG. 12A).

Further, as described above, the T value among the values specifying the toned white is calculated based on the total optical transmittance S in the white portion Pw of the real print RP in this embodiment. In a case where the total optical transmittance S is set to be calculated by the second method, the user selects either the white-backing color measurement or the black base color measurement in the background selection area Se2 of the UI window W2 for color measurement and simultaneously selects the measurement button B3, thereby performing the color measurement using the selected substrate. In this instance, based on the reflectance Rn and Rn obtained by the color measurement and the previously measured substrate transmittance Tgn, the toned white designation module 330 (FIG. 4) calculates the total optical transmittance S2 by using Equations 2 and 3, and the T value is calculated based on the calculated total optical transmittance S2. In this instance, the toned white designation module 330 functions as the acquisition unit and the determination unit in the invention.

Further, in a case where the total optical transmittance S is set to be calculated by the third method, the user selects first either the white-backing color measurement or the black base color measurement in the background selection area Se2 of the UI window W2 for color measurement and simultaneously selects the measurement button B3, thereby performing the color measurement using the selected substrate. After that, the user selects the other of the white-backing color measurement and the black base color measurement in the background selection area Se2 of the UI window W2 for color measurement and simultaneously selects the measurement button B3, thereby performing the color measurement using the selected substrate. In this instance, based on the reflectance Ran, Ragn, Rbn and Rbgn obtained by the color measurement and the previously measured backing transmittance Tagn and Tbgn, the toned white designation module 330 (FIG. 4) calculates the total optical transmittance S3 by using Equations 4 to 6, and the T value is calculated based on the calculated total optical transmittance S2. In this instance, the toned white designation module 330 functions as the acquisition unit and the determination unit in the invention.

In a case where the spectral photometer can be used as the colorimeter CM, it is possible to calculate the total optical transmittance S by the first method. In this instance, the toned white designation module 330 (FIG. 4) calculates the total optical transmittance S1 by using Equation 1 based on the transmittance Tn in each wavelength obtained by the color measurement, and calculates the T value based on the calculated total optical transmission S1. In this instance, the toned white designation module 330 functions as the acquisition unit and the determination unit in the invention. Since the colorimetric measurement for calculating the total optical transmittance S by the first method is not influenced by the color of the substrate, it is not necessary to select the substrate in the background selection area Se2 of the UI window W2 for color measurement, in a case where the total optical transmittance S is calculated by the first method.

If the color measurement is completed, the value (at least either the Lab value or the T value) based on the colorimetric measurement is obtained (step S360 in FIG. 10), and then is displayed in the colorimetric value display box Bo2 (step S370). If the user selects the OK button B4, the UI window W1 for the toned white designation (FIG. 11A) is again displayed. In this instance, the display of the sample image display area Sa or the value input box Bo1 of the UI window W1 for the toned white designation is changed to the display based on the colorimetric result (step S380). After the color measurement is performed, the user may collect the value (Lab value and T value) obtained based on the colorimetric result in the UI window W1 for the toned white designation.

In a case where it is judged in step S320 of FIG. 10 that the operation is performed (Yes in step S320) and it is judged that the operation is performed on the OK button B2 (Yes in step S330), the UI control module 332 (FIG. 4) sets the color specified by the Lab value and the T value which are obtained and displayed at that time, as the color of the toned white image, and stores the Lab value and the T value (step S390).

By the above processing, the user can designate the color of the toned white image exactly and easily. In particular, the user can designate the color of the toned white image more exactly and easily, by designating the Lab value and the T value of the toned white based on the colorimetric result by the colorimeter CM. Further, in this embodiment, since the toned white can be designated by the Lab value and the T value, it is possible to accurately designate the value of the color including the concentration of the toned white image. In addition, since the designated color is displayed in the sample image display area Sa in the UI window W1 for the toned white designation, the user can designate the color easily while verifying the displayed color.

In this embodiment, the T value among the values specifying the toned white can be calculated based on the total optical transmittance S in the white portion Pw of the real print RP, and the total optical transmittance S in the white portion Pw of the real print RP can be calculated by using one of the first method to the third method. In a case in which the total optical transmittance S in the white portion Pw of the real print RP is calculated by the first method, it is possible to calculate the total optical transmittance with sufficient precision with high compatibility to the sensitive evaluation, in comparison with the measurement by the sensitive evaluation or the hazemeter and, simultaneously, it is possible to calculate the total optical transmittance with high accuracy in the white portion Pw of the real print RP which reflects the light in almost whole wavelengths of the visible light by letting the integration value of the transmittance Tn in each wavelength as the total optical transmittance S. Further, in the case of calculating the total optical transmittance S in the white portion Pw of the real print RP by the second method, in comparison with the measurement by the sensitive evaluation or the hazemeter, it is possible to easily calculate the total optical transmittance with high accuracy in high comparison with the sensitive evaluation, without using the spectral photometer which is an expensive and extensive colorimeter. Further, since the value obtained by integrating the transmittance Tn of each wavelength is determined as the total optical transmittance S, it is possible to calculate the total optical transmittance with high accuracy with respect to the white portion Pw of the real print RP reflecting the light in almost all wavelengths of the visible light. In addition, in the case of calculating the total optical transmittance S in the white portion Pw of the real print RP according to the third method, in comparison with the measurement using the sensitive evaluation or the hazemeter, it is possible to easily calculate the total optical transmittance with high accuracy in high comparison with the sensitive evaluation, without using the spectral photometer which is an expensive and extensive colorimeter. Further, since the effect of the substrate (the color of the substrate) is excluded from the calculation of the total optical transmittance S by obtaining the difference between the transmittances Tn calculated from two substrates, it is possible to calculate the total optical transmittance with high accuracy. Moreover, according to the third measurement method of the total optical transmittance S, since the value obtained by integrating the transmittance Tn of each wavelength is determined as the total optical transmittance S, it is possible to calculate the total optical transmittance S with high accuracy with respect to the white portion Pw reflecting the light in almost all wavelengths of the visible light.

In this instance, the stored Lab value and the T value are combined with the white image data WIdata (refer to FIG. 7C). That is, the Lab value and the T value correspond to the pixels allocated with data (W=255) displaying the formation of the toned white image in the white image data WIdata. The white image data WIdata corresponding to the Lab value and the T value is herein referred to as the toned white image data.

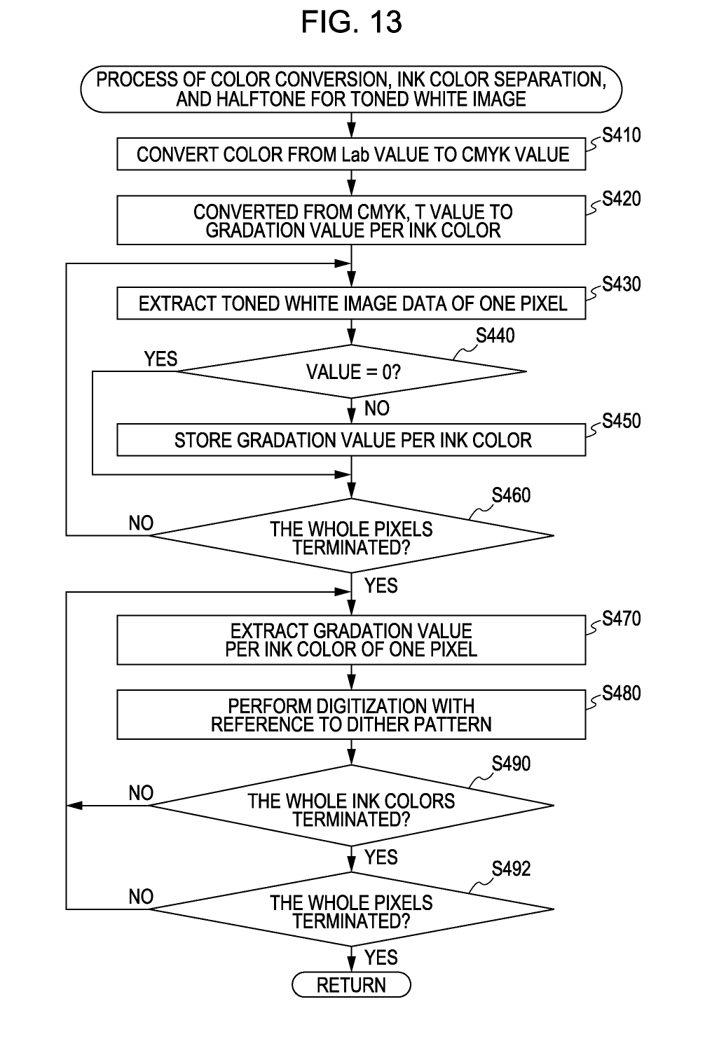

In step S230 of the processing (FIG. 9) by the printer driver 300, the printer driver 300 executes the color conversion processing for toned white image, the ink color separation processing, and the halftone processing. FIG. 13 is a flowchart illustrating the flow of the color conversion processing, the ink color separation processing and the halftone processing with respect to the toned white image. In step S410, the toned white image-color conversion module 340 (FIG. 4) color-converts the Lab value stored in step S390 of the toned white designation process (FIG. 10) into the CMYK value. The color conversion is performed with reference to the toned white image-lookup table LUTw (FIG. 4).

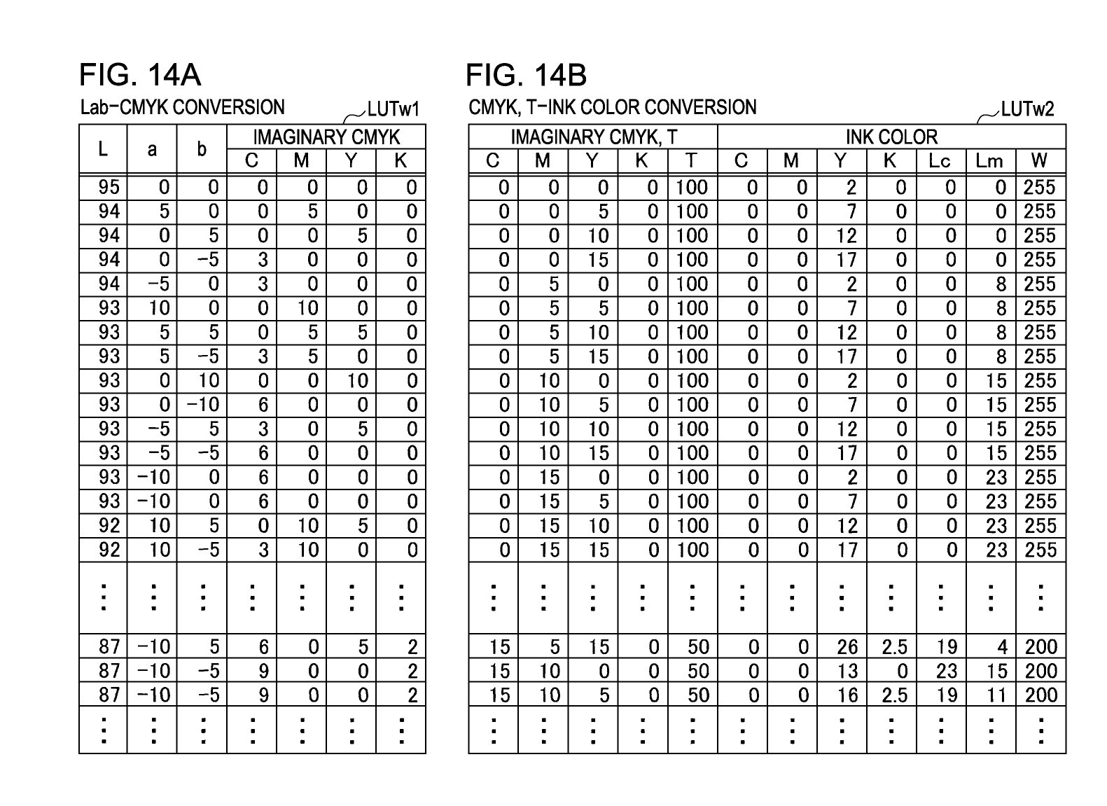

FIGS. 14A and 14B are diagrams partially illustrating an example of the toned white image-lookup table LUTw. FIG. 14A shows the toned white image-lookup table LUTw1 referred when the color is converted from the Lab value to the CMYK value. As shown in FIG. 14A, a corresponding relationship of the previously set Lab value and the CMYK value is defined in the toned white image-lookup table LUTw1. In this instance, each gradation value of CMYK is defined as a value in a range of 0 to 100 in the toned white image-lookup table LUTw1. The toned white image-color conversion module 340 converts the Lab value into the CMYK value with reference to the toned white image-lookup table LUTw1.

In step S420 (FIG. 13), the toned white image-ink color separation processing module 350 (FIG. 4) performs the ink color separation processing which converts the combination of the CMYK value determined in step S410 and the T values stored in step S390 of the toned white designation process (FIG. 10) into a toning value per ink color. As described above, the printer 100 of this embodiment performs the printing by using 7 colors in total of the cyan (C), the magenta (M), the yellow (Y), the black (K), the light cyan (Lc), the light magenta (Lm) and the white (W). Accordingly, in ink color separation processing, the combination of the CMYK value and the T value is converted into the toning value for each of 7 ink colors. The ink color separation processing is executed with reference to the toned white image-lookup table LUTw (FIG. 4). FIG. 14B shows a toned white image-lookup table LUTw2 referred when the combination of the CMYK value and the T value is converted into the toning value for each of 7 ink colors. As shown in FIG. 14B, a corresponding relationship between the combination of the CMYK value and the T value previously set, and the toning value of each ink color is defined in the toned white image-lookup table LUTw2. In this instance, the toning value of the ink color is defined as a value in a range of 0 to 255 in the toned white image-lookup table LUTw2. The toned white image-ink color separation processing module 350 converts the combination of the CMYK and the T value into the toning value per the ink color with reference to the toned white image-lookup table LUTw2.

As shown in FIG. 14B, in this embodiment, four ink colors of the yellow (Y), the black (K), the light cyan (Lc) and the light magenta (Lm) among 6 ink colors are used in the formation of the white toning (adjusting the white color by mixing the white ink with ink of another color), except for white, and 2 ink colors of cyan (C) and magenta (M) ink are not used. That is, deep ink among two kinds of ink of pale ink and deep ink with respect to the same color is not used in the white toning.

In step S430 (FIG. 13), the toned white image-ink color separation processing module 350 (FIG. 4) extracts the data of one pixel from the toned white image data. In step S440, the toned white image-ink color separation processing module 350 judges whether the extracted value of the pixel is a value (zero) displaying that the toned white image is not formed, or a value (255) displaying that the toned white image is formed. In a case where it is judged that the value of the pixel is judged as 255 (No in step S440), the toned white image-ink color separation processing module 350 saves the toning value per ink color determined in step S420 (step S450). In a case where the value of the pixel is 0 (zero) (Yes in step S440), the processing of step S450 is skipped.

The processing from the step S430 to 5450 in FIG. 13 is repeatedly executed until the processing of the toned white image data on all pixels is completed (refer to step S460). In a case where the processing of the toned white image data on the entire pixels is completed (Yes in step S460), the toned white image-halftone processing module 360 (FIG. 4) extracts the toning value per ink color of one pixel (step S470), and performs the binarization processing (halftone processing) on every ink color with reference to a dither pattern for every ink color (step S480). The binarization processing is executed with reference to the previously set toned white image-halftone resource HTw (FIG. 4). In this instance, the toned white image-halftone resource HTw may be set by attaching importance on filling of dots in the toned white image. The binarization processing is repeatedly executed until the processing on all pixels is completed (refer to step S490). Further, the processing from step S470 to 5490 is repeatedly executed until the processing on the whole pixels is terminated (step S492).

By the color conversion processing, the ink color separation processing and the halftone processing on the toned white image shown in FIG. 13, the toned white image-dot data defining ON/OFF of the dot of each ink color of each pixel when the toned white image is formed is generated.

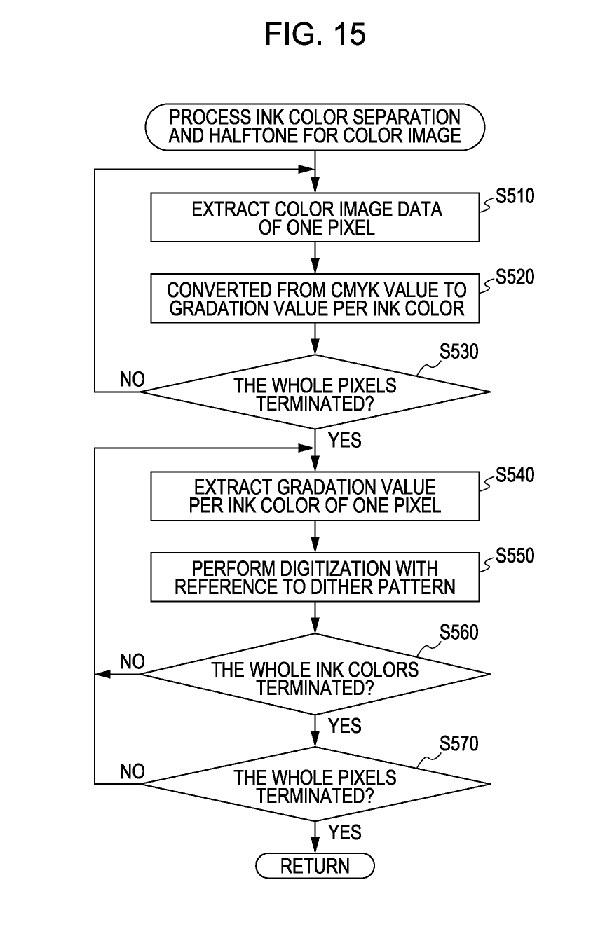

In step S240 of the processing (FIG. 9) by the printer driver 300, the printer driver 300 executes the color conversion processing, the ink color separation processing and the halftone processing on the color image. FIG. 15 is a flowchart illustrating the flow of the color conversion processing, the ink color separation processing and the halftone processing on the color image. In step S510, the color image-ink color separation processing module 310 (FIG. 4) extracts the data of one pixel from the color image data. In step S520, the color image-ink color separation processing module 310 performs the ink color separation processing of converting the extracted data (CMYK value) of one pixel into the toning value per ink color. As described above, the printer 100 of this embodiment performs the printing by using 7 ink colors in total of the cyan (C), the magenta (M), the yellow (Y), the black (K), the light cyan (Lc), the light magenta (Lm) and the white (W). Accordingly, in the ink color separation processing, the CMYK value is converted into the toning value for each of 7 ink colors. The ink color separation processing is executed with reference to the color image-lookup table LUTc (FIG. 4).

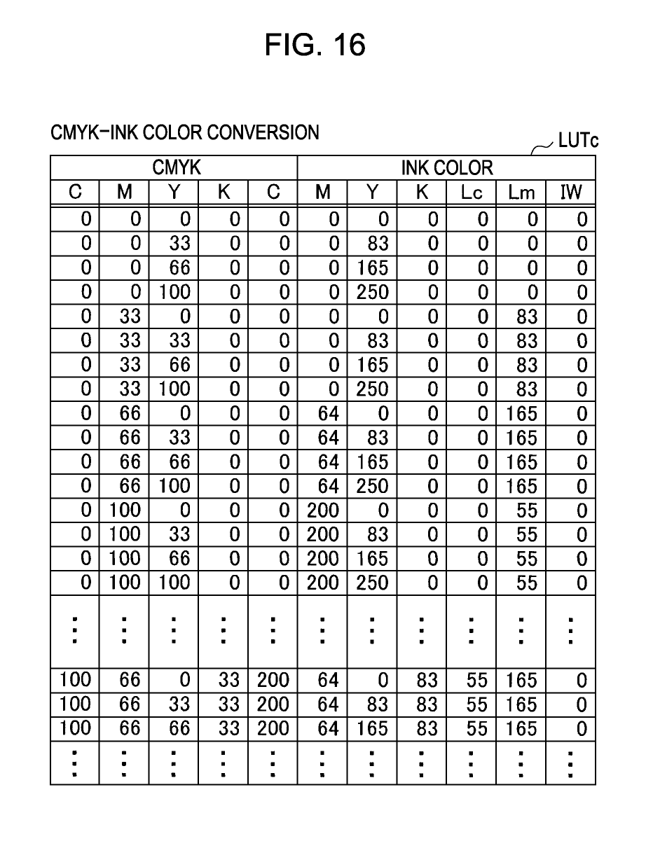

FIG. 16 is a diagram partially illustrating an example of the color image-lookup table LUTc. As shown in FIG. 16, a corresponding relationship of the previously set CMYK value of the each gradation value of the ink colors is defined in the color image-lookup table LUTc. Further, in the color image-lookup table LUTc, each toning value of CMYK is defined as a value in a range of 0 to 100, and a toning value of the ink color is defined as a value in a range of 0 to 255. The color image-ink color separation processing module 310 converts the CMYK value into the toning value with reference to the color image-lookup table LUTc. Further, as shown in FIG. 16, ink of 6 colors except for white color is used at the time of forming the color image in this embodiment, and the white ink is not used.

The processing of the steps S510 and S520 in FIG. 15 is repeatedly executed until the processing on all pixels of color image data are completed (refer to step S530). In a case where the processing on the whole pixels is completed (Yes in step S530), the color image-halftone processing module 320 (FIG. 4) extracts the tone value for every ink color of one pixel (step S540), and performs the binarization processing (halftone processing) on every ink color with reference to a dither pattern for every ink color (step S550). The binarization processing is executed with reference to the previously set toned white image-halftone resource HTc (FIG. 4). In this instance, the color image-halftone resource HTc may be set by attaching importance on suppression of granular sensation. The binarization processing is repeatedly executed until the processing on all ink colors is completed (refer to step S560). Further, the processing from step S540 to step S560 is repeatedly executed until the processing on all pixels is completed (refer to step S570).

By the color conversion processing, the ink color separation processing and the halftone processing on the color image shown in FIG. 15, the color image-dot data defining ON/OFF of the dot of each ink color of each pixel when the color image is formed is generated.

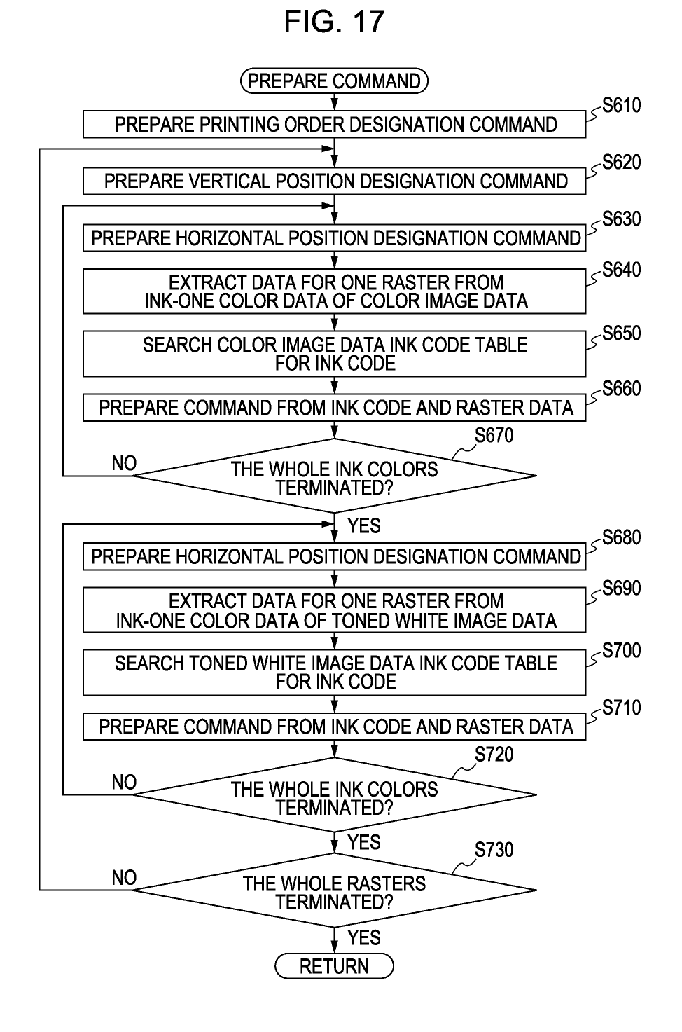

In step S250 in the processing (FIG. 9) by the printer driver 300, the command preparation module 370 (FIG. 4) of the printer driver 300 prepares the command preparation processing. FIG. 17 is a flowchart illustrating the flow of the command preparation processing.

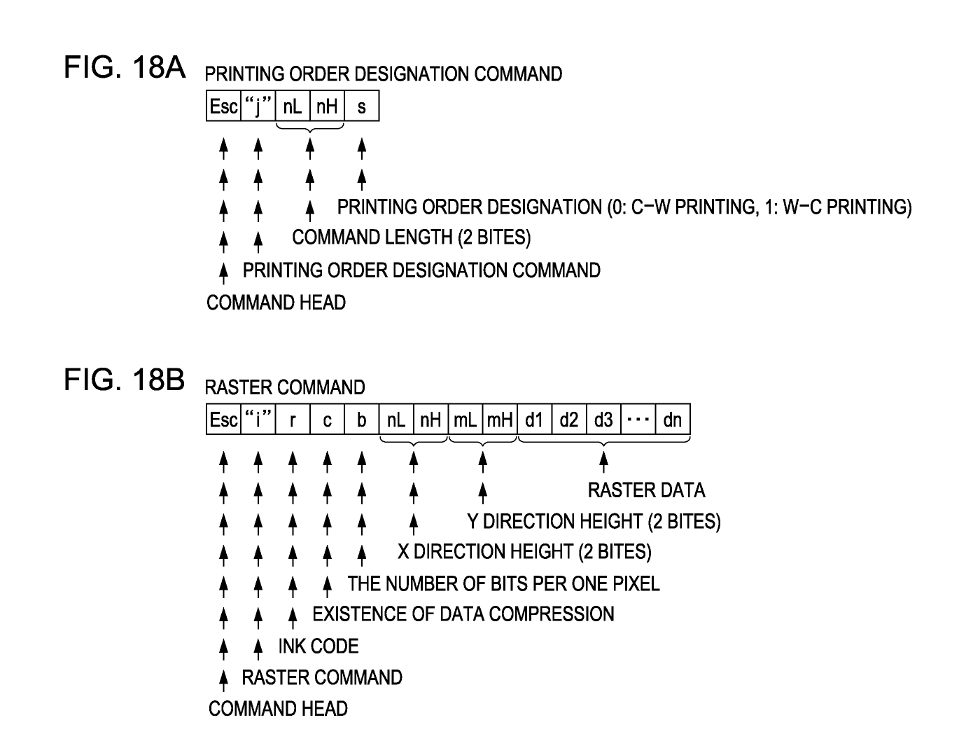

In step S610 of the command preparation processing (FIG. 17), the command preparation module 370 (FIG. 4) prepares the printing order designation command based on the printing order designation information SS output from the application program AP. FIGS. 18A and 18B are diagrams illustrating an example of the command prepared by the command preparation processing. FIG. 18A illustrates an example of the printing order designation command. As shown in FIG. 18A, the printing order designation command includes an identifier displaying a command head, an identifier displaying the printing order designation command, a command length (2 bites) and the printing order designation. In the printing order designation, for example, the value ‘0’ displays the C-W printing (printing order of forming the color image Ic and forming the toned white image Iw on the color image Ic), and the value ‘1’ displays the W-C printing (printing order of forming the toned white image Iw and forming the color image Ic on the toned white image Iw). The command preparation module 370 identifies the printing order with reference to the printing order designation information SS, and prepares the printing order designation command designating the specified printing order.

In step S620 (FIG. 17), the command preparation module 370 (FIG. 4) prepares a vertical position designation command based on the color image-dot data received from the color image-halftone processing module 320 and the toned white image-dot data received from the toned white image-halftone processing module 360. The vertical position designation command is a command for designating the start position of the image along the vertical direction (Y direction). The vertical position designation command is prepared as a command common to the entire ink.

Next, the command preparation module 370 (FIG. 4) prepares a raster command corresponding to the color image through the processing from step S630 to step S670 (FIG. 17). In step S630, the command preparation module 370 prepares a horizontal position command for the one selected ink color based on the color image-dot data. The horizontal position designation command is a command for designating the start position of the image along a horizontal direction (X direction) for one ink color at the time of forming the color image. The command preparation module 370 sets an appropriate image start position with reference to the color image-dot data for one ink color, and prepares the horizontal position designation command.

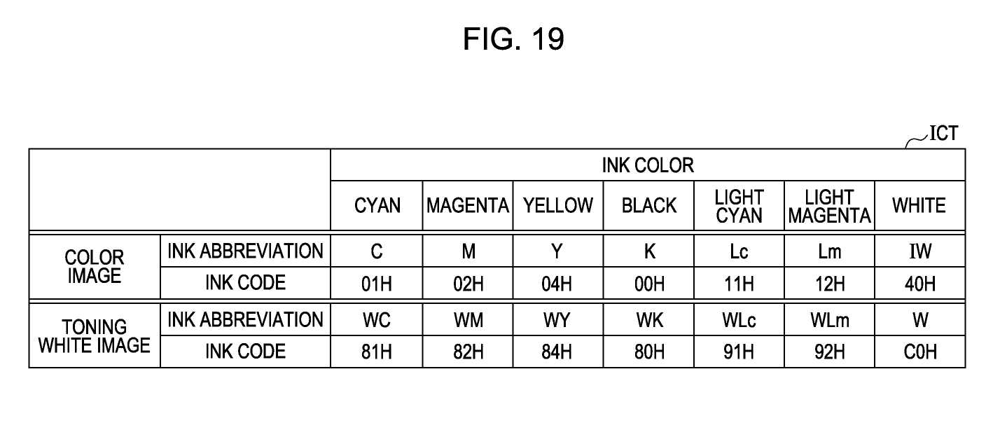

In step S640 (FIG. 17), the command preparation module 370 (FIG. 4) extracts the dot data for one raster with respect to the one selected ink color from the dot data for the color image. In step S650, the command preparation module 370 searches the ink code with reference to the ink code table ICT. FIG. 19 is a diagram illustrating one example of the content of the ink code table ICT. As shown in FIG. 19, an inherent abbreviation and an ink code for ink are allocated to each ink color in this embodiment. Further, an abbreviation and an ink code for 2 kinds of different ink for the color image and the toned white image are allocated to one ink color in this embodiment. That is, the ink abbreviation and the ink code correspond constantly to each of plural ink colors and a combination of the color image and the toned white image. For example, the cyan is allocated with the ink abbreviation ‘C’ and the ink code ‘01H’ for the color image, and is allocated with ink abbreviation ‘WC’ and the ink code ‘81H’ for the toned white image. Similarly, the white is allocated with the ink abbreviation ‘IW’ and the ink code ‘40H’ for the color image, and is allocated with ink abbreviation ‘W’ and the ink code ‘C0H’ for the toned white image. In step S650, the command preparation module 370 searches the ink code for color image of the ink code table ICT.

In step S660 (FIG. 17), the command preparation module 370 (FIG. 4) prepares the raster command based on the dot raster for extracted one raster and the searched ink code. FIG. 18B illustrates an example of the raster command. As shown in FIG. 18B, the raster command includes an identifier displaying a command head, an identifier displaying a raster command, and ink code, an identifier displaying presence or absence of data compression, the number of bits per one pixel, length (2 bites) of X-direction, length (2 bites) of Y-direction, and raster data (dot data). In this instance, the raster command corresponds to a printing command, and the raster data included in the raster command corresponds to the printing data.

The processing from step S630 to S660 of the command preparation processing (FIG. 17) is repeatedly executed until it is completed with respect to all ink colors used in the formation of the color image. That is, in a case in which there is an ink color which is not yet to be processed (No in step S670), one ink color which is not yet to be processed is selected, and the processing from step S630 to step S660 is performed on the selected ink color. If the processing on the whole ink is completed (Yes in step S670), preparation of the raster command corresponding to each ink color used in the formation of the color image is completed with respect to one raster.

Next, the command preparation module 370 (FIG. 4) prepares the raster command corresponding to the toned white through the processing from the step S680 (FIG. 17) to step S720. In the step S680, the command preparation module 370 prepares the horizontal position designation command for one selected ink color based on the toned white image-dot data. The horizontal position designation command is a command for designating the start position of the image along the horizontal direction (X-direction) with respect to one ink color at the time of forming the toned white image. The command preparation module 370 sets the appropriate image start position with reference to the toning image-dot data for one ink color, and prepares the horizontal position designation command.

In step S690 (FIG. 17), the command preparation module 370 (FIG. 4) extracts the dot data for one raster with respect to one selected ink color from the toned white image-dot data. In step S700, the command preparation module 370 searches the ink code with reference to the ink code table ICT. The command preparation module 370 searches the ink code for the toned white image of the ink code table ICT (FIG. 19).

In step S710 (FIG. 17), the command preparation module 370 (FIG. 4) prepares the raster command (refer to FIG. 18B) based on the dot data for one extracted raster and the searched ink code. The processing from step S680 to step S710 in the command preparation processing is repeated executed until it is completed with respect to all ink colors used in the formation of the toned white image. That is, in a case in which there is an ink color which is not yet to be processed (No in step S720), one ink color which is not yet to be processed is selected, and the processing from step S680 to step S710 is performed on the selected ink color. If the processing on the whole ink is completed (Yes in step S720), preparation of the raster command corresponding to each ink color used in the formation of the tone white image is completed with respect to one raster.

The processing from step S620 to step S720 in the command preparation processing (FIG. 17) is repeatedly executed until it is completed with respect to the whole raster of the print image PI. That is, in a case in which there is a raster which is not yet to be processed (No in step S730), a raster which is not yet to be processed (raster below one raster to be processed at previous time) is selected, and the processing from step S620 to step S720 is performed on the selected raster. If the processing on the whole raster is completed (Yes in step S730), preparation of the command corresponding to each ink color used in the formation of the color image and the toned white image is completed with respect to one raster.

In step S260 in the processing (FIG. 9) by the printer driver 300, the printer driver 300 transmits the printing order designation command, the vertical position designation command, the horizontal position designation command and the raster command which are prepared in step S250 to the printer 100. With that, the processing of the printer driver 300 is completed.

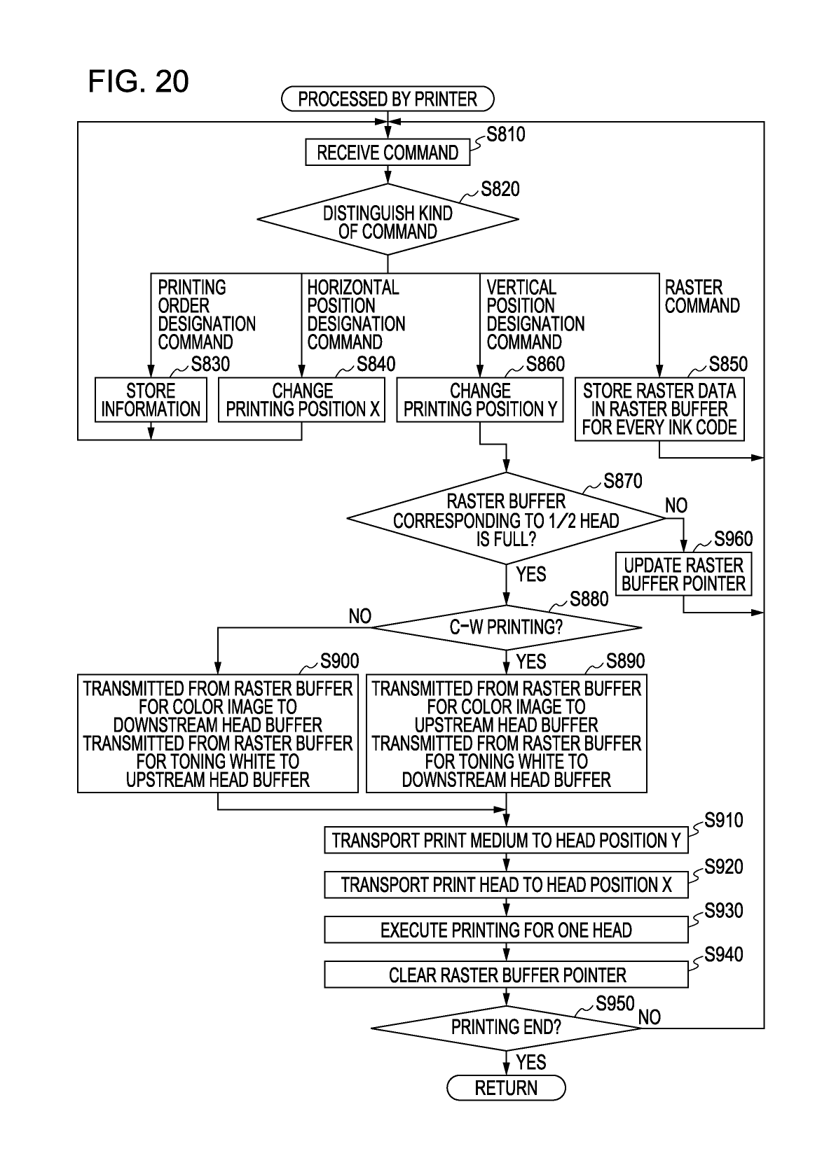

In step S130 of the printing process (FIG. 6), the processing of the printer 100 is executed. FIG. 20 is a flowchart illustrating the flow of the processing by the printer 100. In step S810, the CPU 110 (FIG. 3) executing the command processing module 112 (FIG. 5) of the printer 100 receives the command transmitted from the printer driver 300 of the PC 200. The CPU 110 distinguishes the kind of the received command (step S820), and executes the processing according to the kind of the command. In a case in which the received command is the printing order designation command, the CPU 110 preserves the information displaying the printing order designated by the printing order designation command in the RAM 130 (step S830). If the received command is the horizontal position designation command, the CPU updates the printing start position X of the horizontal direction (step S840).

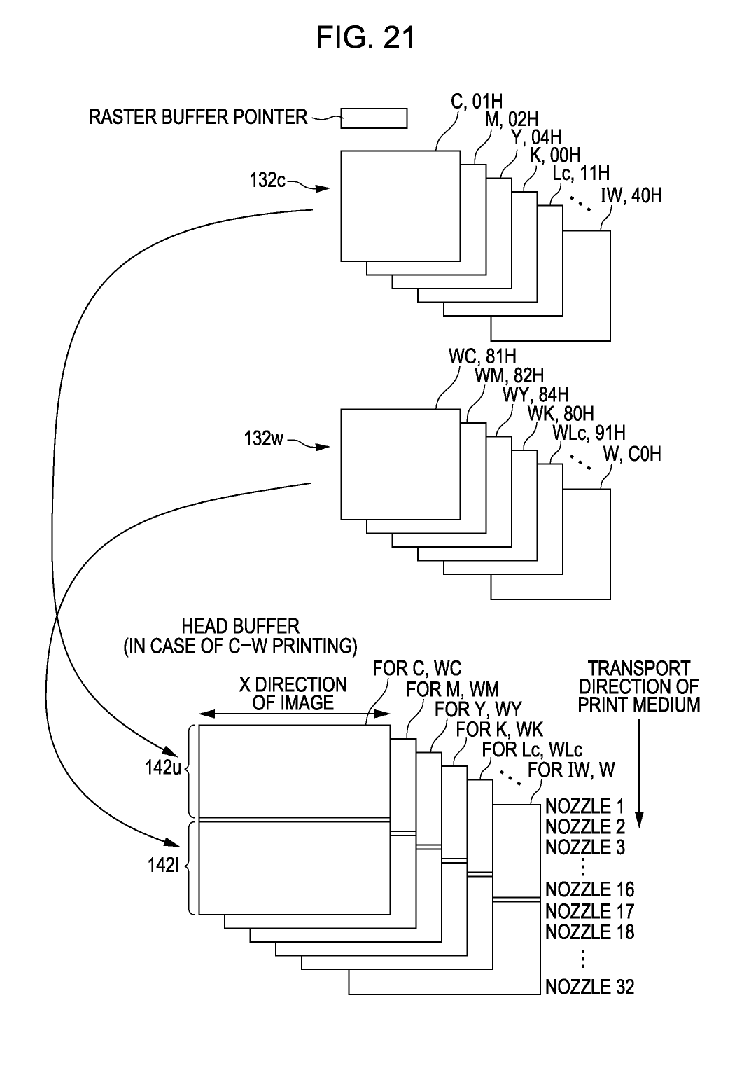

Further, in a case in which the received command is the raster command, the CPU 110 (FIG. 3) executing the command processing module 112 (FIG. 5) stores the raster data (dot data) contained in the raster command in the raster buffer 132 (FIG. 5) for every ink code (step S850). FIG. 21 is a diagram illustrating the detailed configuration of the raster buffer and the head buffer. The upper end of the FIG. 21 illustrates a raster buffer 132c for color image, and a middle portion illustrates a raster buffer 132w for toned white image. As shown in FIG. 21, the raster buffer 132 is allocated with a region for every ink code (refer to FIG. 19). That is, the raster buffer 132c for color image is constituted of a collection of regions corresponding to each ink code of the color image, and the raster buffer 132w for toned white image is constituted of a collection of regions corresponding to each ink code for the toned white image. A size of each region in the X-direction of the raster buffer 132 corresponds to an image size, and the size in the Y-direction is a size of ½ or more of a height of the print head 144. The raster buffer 132 has a raster buffer pointer of Y-direction displaying how far the raster data is received.

The lower end of FIG. 21 illustrate the head buffer 142 (FIG. 5). As shown in FIG. 21, the head buffer 142 is allocated with a region for 7 ink colors. That is, the head buffer 142 is constituted of a collection of a region for the cyan (for C and WC), a region for the magenta (for M and WM), a region for yellow (for Y and WY), a region for the black (for K and WK), a region for the light cyan (for Lc and WLc), a region for the light magenta (Lm and WLm), and a region for the white (for IW and W). The size of each region in the X-direction of the raster buffer 142 corresponds to a scanning distance of a carriage, and the size in the Y-direction corresponds to the number of nozzles constituting a nozzle array 146 of the print head 144. Further, each region of the head buffer 142 for every ink color is divided into an upstream head buffer 142u and a downstream head buffer 142l.

FIGS. 22A to 22C are diagrams illustrating the configuration of the printer head 144 of the printer 100. As shown in FIGS. 22A and 22B, the print head 144 is provided with the nozzle array 146 corresponding to each of 7 ink colors. The nozzle array 146 is formed to be extended in the Y-direction (transport direction of print medium). Further, as shown in FIG. 22C, each nozzle array 146 is constituted of 32 nozzle groups arrayed along the transport direction of the print medium. The nozzle group (from the first nozzle (nozzle 1) to the sixteenth nozzle (nozzle 16)) occupying the half portion of the upstream side along the transport direction of the print medium is referred to as an upstream nozzle group, and the nozzle group (from the seventeenth nozzle (nozzle 17) to the thirty-second nozzle (nozzle 32)) occupying the half portion of the downstream side along the transport direction of the print medium is referred to as a downstream nozzle group.

As shown in FIG. 22A, at the time of W-C printing, the formation of the toned white image is performed by using the upstream nozzle group of each nozzle array 146 of the print head 144, and the formation of the color image is performed by using the downstream nozzle group. Further, as shown in FIG. 22B, at the time of C-W printing, the formation of the color image is performed by using the upstream nozzle group of each nozzle array 146 of the print head 144, and the formation of the toned white image is performed by using the downstream nozzle group.

As shown in FIG. 21, the upstream head buffer 142u is the head buffer 142 corresponding to an upstream portion (upstream nozzle group) of the print head 144 along the transport direction of the print medium, and the downstream head buffer 142l is the head buffer 142 corresponding to a downstream portion (downstream nozzle group) of the print head 144 along the transport direction of the print medium.

In step S850 of FIG. 20, the CPU 110 (FIG. 3) is stored with the raster data at a position designated by the raster buffer pointer of the raster buffer 132 corresponding to the ink code with reference to the ink code included in the received raster command. For this reason, the CPU 110 can classify the raster data in the appropriate raster buffer 132, without being aware of which the raster command corresponds to the color image or the toned white image.

The CPU 110 (FIG. 3) executed by the command processing module 112 (FIG. 5) updates the printing start position Y of the vertical direction in a case where the received command is the vertical position designation command (step S860). Next, the CPU 110 judges whether the raster buffer 132 corresponding to ½ of the height of the print head 144 (FIG. 5) is full or not (i.e., whether the raster data is stored or not) (step S870). In a case in which it is judged that it is not yet full (No in step S870), the CPU 110 updates the raster buffer pointer of the raster buffer 132 (step S880).

If the raster data is stored in the raster buffer 132 corresponding to ½ of the height of the print head 144 by the repetition of the above-described processing, it is judged that the raster buffer 132 corresponding to ½ of the height of the print head 144 is full (Yes in step S870). In this instance, the CPU 110 (FIG. 3) judges whether the printing order is the C-W printing or the W-C printing, based on the information displaying the printing order preserved in the RAM 130 (step S880). If it is judged that the printing order is the C-W printing (Yes in step S880), the CPU 110 transmits the raster data to the upstream head buffer 142u (FIG. 5) from the raster buffer 132c for color image, and simultaneously, transmits the raster buffer to the downstream head buffer 142l (FIG. 5) from the raster buffer 132w for toned white image (step S890). FIG. 21 illustrates an aspect in which the raster data is transmitted to the upstream head buffer 142u from the raster buffer 132c for color image and the raster buffer is transmitted to the downstream head buffer 142l from the raster buffer 132w for toned white image, in a case the printing order is the C-W printing. Consequently, the C-W printing (FIG. 22A) in which the formation of the color image is performed by using the upstream nozzle group of each nozzle array 146 of the print head 144, and the formation of the toned white image is performed by the downstream nozzle group is prepared.

If it is judged that the printing order is the W-C printing (No in step S880), the CPU 110 transmits the raster data to the downstream head buffer 142l (FIG. 5) from the raster buffer 132c for color image, and simultaneously, transmits the raster buffer to the upstream head buffer 142u from the raster buffer 132w for toned white image (step S900). Consequently, the W-C printing (FIG. 22A) in which the formation of the toned white image is performed by using the upstream nozzle group of each nozzle array 146 of the print head 144, and the formation of the color image is performed by the downstream nozzle group is prepared.

Next, the CPU 110 (FIG. 3) controls the print medium transport controller 160 and the print medium transport motor 162 to transport the print medium PM to the head position Y (sub scanning) (step S910), controls the CR controller 150 and the CR motor 152 to move the print head 144 to the printing start position X (step S920), and performs the main scan to execute the main scan the printing for the height of the print head 144 (step S930). In this instance, in the W-C printing (refer to FIG. 22A), the formation of the toned white image by the upstream nozzle group (refer to FIG. 22C) of the nozzle array 146 of the print head 144 and the formation of the color image by the downstream nozzle group are executed in combination. Further, in the C-W printing (refer to FIG. 22B), the formation of the color image by the downstream nozzle group of the nozzle array 146 of the print head 144 and the formation of the toned white image by the upstream nozzle group are executed in combination.

Next, the CPU 110 (FIG. 3) clears the raster buffer pointer of the raster buffer 132 (step S940), judges whether the printing process on the whole print image PI is completed or not (step S950), and repeatedly executes the processing from step S810 to step S940 until it is judged that the printing process is completed. If the printing process is completed, the printing process (FIG. 6) is completed.

As described above, the printing system 10 of this embodiment can execute the printing process to form the color image and the toned white image on the print medium PM by using a plurality of ink including the white color. At the time of the printing process by the printing system 10, each of seven nozzle arrays 146 corresponding to 7 ink colors provided on the print head 144 of the printer 100 is divided into the upstream nozzle group and the downstream nozzle group (refer to FIG. 22C). In the case of the W-C printing (refer to FIG. 22A), the toned white image is formed by ejecting the ink from the upstream nozzle group. In the case of the C-W printing (refer to FIG. 22B), the toned white image is formed by ejecting the ink from the downstream nozzle group. For this reason, in any case of the W-C printing and the C-W printing, the toned white image can be formed by using the white ink and at least one ink color except for the white color. Consequently, in the printing system 10 of this embodiment, when the printing process of forming the color image and the toned white image on the print medium PM by using the plurality of ink colors including the white color is executed, the toned white image can be set to the desired color.

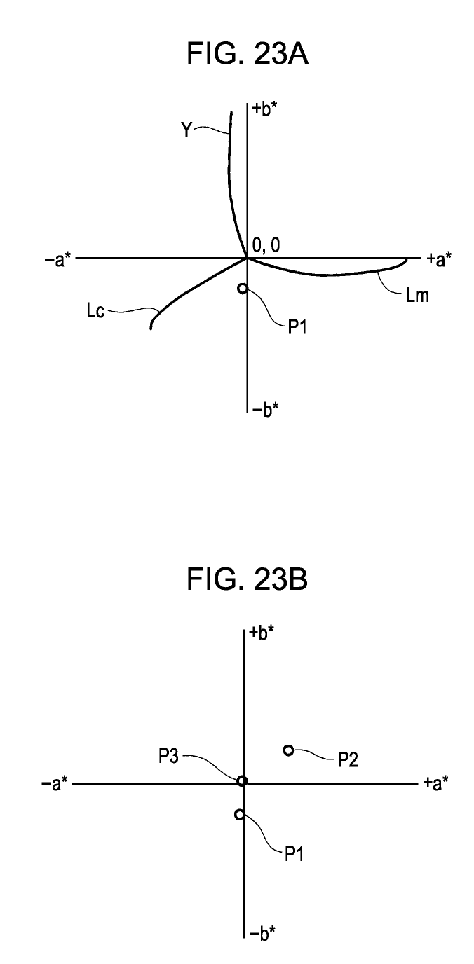

FIGS. 23A and 23B are diagrams illustrating a concept of the white toning adjusting the white color. FIG. 23A illustrates one example of the color position P1 of the white ink of the printer 100 on the a*-b* plane, and FIG. 23B shows one example of a position P2 of the white color of a target and a position P3 of a color of which a predetermined quantity of yellow ink is mixed with the white ink of the print 100. As shown in FIG. 23B, for example, the color of the toned white image can be close to the white color of the target by mixing the yellow ink with the white ink of the printer 100. Further, for example, the color of the toned white image can be further close to the white color of the target by adding a predetermined quantity of the light magenta ink. As such, at the time of forming the toned white image, the toned white image can be set to the desired color by using the white ink and at least one ink except for the white color.

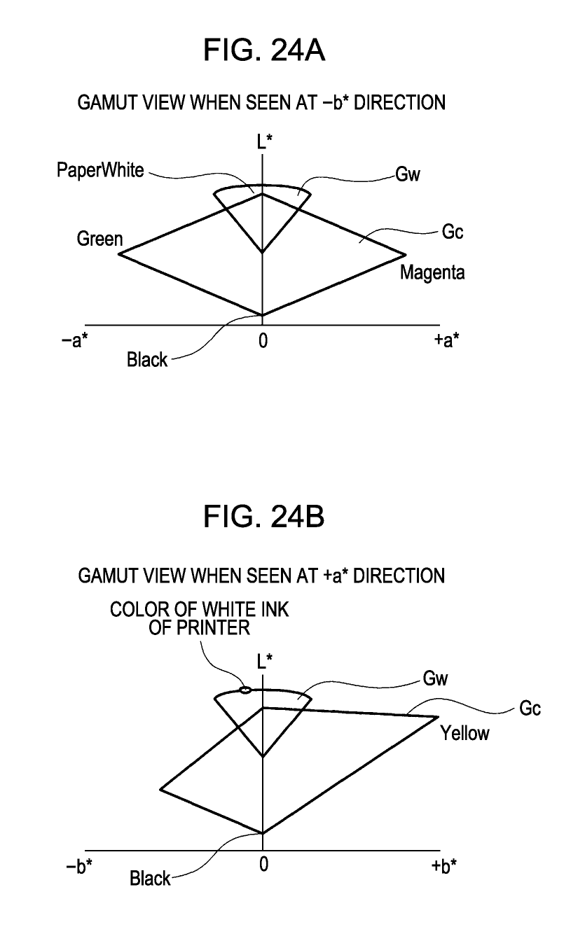

FIGS. 24A and 24B are diagrams illustrating an example of a color reproduction region (gamut) of the color image and the toned white image. FIG. 24A illustrates a gamut Gc of the color image and a gamut Gw of the toned white image, which is seen at a −b* direction. FIG. 24B illustrates the gamut Gc of the color image and the gamut Gw of the toned white image, which is seen at a +a* direction. As described above, in this embodiment, one (first image forming unit) of the upstream nozzle group and the downstream nozzle group of the nozzle array 146 of the print head 144 is used in the formation of the color image (first image). Further, 6 ink colors (first ink group), expect for the white color, among 7 ink colors are used in the formation of the color image, and the white ink is not used. The other (second image forming unit) of the upstream nozzle group and the downstream nozzle group of the nozzle array 146 of the print head 144 is used in the formation of the toned white image (second image). Further, 5 ink colors (second ink group) of white, yellow, black, light cyan and light cyan magenta ink among 7 ink colors are used in the formation of the toned white image, and the white 2 ink colors of cyan and magenta ink are not used. Since the color reproduction region of the first ink group and the color reproduction region of the second ink group are different from each other, the gamut Gc (first color reproduction region) of the color image and the gamut Gw (second color reproduction region) of the toned white image are different from each other. In the printing process by the printing system 10 of this embodiment, it is possible to form two images (color image and toned white image) of different color reproduction regions on the print medium PM in an overlapping manner, thereby easily preparing various printed matters including a plurality of images with different color reproduction regions. Further, in the printing process by the printing system 10 of this embodiment, since the formation of the color image and the formation of the toned white image are performed in combination in at least period of the printing, it is possible to effectively and easily prepare various printed matters including a plurality of images with different color reproduction regions.

In addition, according to the printing process by the printing system 10 of this embodiment, in any case of the W-C printing and C-W printing, the formation of the toned white image is performed by using one of the upstream nozzle group and the downstream nozzle group, and simultaneously, the formation of the color image is performed by using the other. As a result, in a case where at lest one portion of the toned white image is overlapped with the color image on the print medium, the toned white image can be set to the desired color.

Moreover, according to the printing process by the printing system 10 of this embodiment, in any case of the W-C printing and C-W printing, the formation of the toned white image by using one of the upstream nozzle group and the downstream nozzle group and the formation of the color image by using the other can be performed in combination in the same main scan (same path). For this reason, by not forming one of the toned white image and the color image on the print medium on the whole, and then forming the other on the print medium on the whole, the color image and the toned white image can be formed on the print medium by once printing process, so that the toned white image can be set to the desired color.

Further, according to the printing process by the printing system 10 of this embodiment, in the case in which the printer 100 receives the printing order designation command (FIG. 18A) designating the printing order from the PC 200 and the printing order of forming firstly the color image is designated, the upstream nozzle group is set as the nozzle group used in the formation of the color image, and simultaneously the downstream nozzle group is set as the nozzle group used in the formation of the toned white image. In the case in which the printing order of forming firstly the toned white image is designated, the upstream nozzle group is set as the nozzle group used in the formation of the toned white image, and simultaneously the downstream nozzle group is set as the nozzle group used in the formation of the color image. For this reason, according to the printing process by the printing system 10 of this embodiment, since the toned white image can be set to the desired color in any case of the C-W printing and the W-C printing, it is possible to cope with a wide use aspect of the printed matter (refer to FIG. 8).

Further, according to the printing system 10 of this embodiment, the ink code included in the raster command (FIG. 18B) is set to constantly correspond to combination with each of 7 ink colors and the color image or the toned white image. For this reason, the CPU 110 of the printer 100 can control the nozzle group (upstream nozzle group or downstream nozzle group) used in the formation of the color image based on the raster command including the ink code corresponding to the color image, and control the nozzle group (upstream nozzle group or downstream nozzle group) used in the formation of the toned white image based on the raster command including the ink code corresponding to the toned white image, without being aware of which the raster command corresponds to the color image or the toned white image.

In addition, according to the printing system 10 of this embodiment, the raster buffer 132 of the printer 100 includes the color image region 132c and the toned white image region 132w (refer to FIG. 5). For this reason, in the CPU 110 of the printer 100, the raster buffer 132 stores the raster data which is included in the raster command having the ink code corresponding to the color image, in the color image region 132c, and the raster data which is included in the raster command having the ink code corresponding to the toned white image, in the toned white image region 132w, thereby controlling the nozzle group used in the formation of the color image and the formation of the toned white image.

Moreover, according to the printing process by the printing system 10 of this embodiment, in the formation of the toned white image, 4 ink colors of yellow (Y), black (K), light cyan (Lc) and light magenta (Lm) ink are used among 6 ink colors except for the white color, and 2 ink colors of cyan (C) and magenta (M) ink are not used. That is, in the formation of the toned white image. That is, the deep ink among two kinds of ink of the pale ink and the deep ink with respect to the same color is not used in the formation of the toned white image. For this reason, according to the printing process of this embodiment, it is possible to suppress deterioration of the image quality of the toned white image (increased sensation of granularity), while the toned white image is set to the desired color. Further, according to the printing process of this embodiment, since the black (K) ink is used in the formation of the toned white image, the brightness of the toned white image can be adjusted, thereby extending the selectable range of the toned white image.

Further, according to the printing process by the printing system 10 of this embodiment, since the toned white (color of the toned white image) can be designated on the UI window W1 for the toned white designation (FIG. 11), it is possible to accurately and easily designate the color of the toned white image when the color image and the toned white image are printed by using the plurality of ink colors including the white color. In particular, according to the printing system 10 of this embodiment, since the color (Lab value and the T value) can be designated based on the colorimetric result by the colorimeter CM, it is possible to accurately and easily designate the color of the toned white image. Further, according to the printing system 10 of this embodiment, since the toned white can be designated by the Lab value and the T value, it is possible to accurately designate the value of the color including the concentration of the toned white image. In addition, according to the printing system 10 of this embodiment, since the designated color is displayed in the sample image display area Sa of the UI window W1 for the toned white image designation, the user can easily designate the color while verifying the displayed color.

### B. Second Embodiment

In the first embodiment, the color of the white region Aw (refer to FIG. 7A) of the print image P1 becomes one color designated by the toned white designation process (step S220 in FIG. 9), and the toned white image is formed as an image of one designated color. By contrast, the color of the white region Aw is allowed to be different for every portion in the second embodiment. That is, in the second embodiment, according to the toned white designation process, it is possible to designate the color (Lab value and T value) for every partial region, in which the white region Aw of the print image PI is divided into a plurality of partial regions.

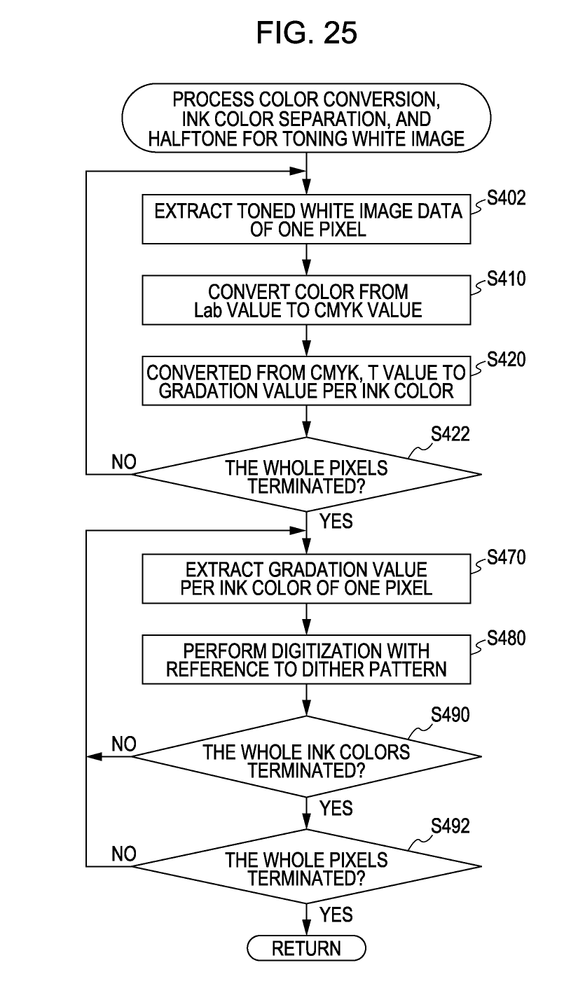

FIG. 25 is a flowchart illustrating the flow of a color conversion processing, an ink color separation processing and a halftone processing with respect to a toned white image according to the second embodiment. In FIG. 25, steps of the like content as that of the step in the first embodiment shown in FIG. 13 are denoted by the same step numerals. In the first embodiment, since the color (Lab value and T value) of each pixel corresponding to the white region Aw of the toned white image data is identical, the color conversion (step S410 in FIG. 13) from the Lab value to the CMYK value or the conversion (S420 in FIG. 13) from the CMYK or T value into the toning value for each ink color is executed common to the whole pixels. By contrast, in the second embodiment, since there is a case in which the color of the pixel corresponding to the region Aw the toned white image data is different for every pixel, one pixel of the toned white image data is extracted (step S402 in FIG. 25), and the color conversion (step S410 in FIG. 25) from the Lab value to the CMYK value or the conversion (S420 in FIG. 25) from the CMYK or T value into the toning value for each ink color is executed on every extracted pixel. The above processing is repeatedly executed until the processing is completed on the entire pixel (refer to step S422 in FIG. 25). The processing (halftone processing) after step S470 in FIG. 25 is identical to the first embodiment shown in FIG. 13.

As described above, in the second embodiment, the color image and the toned white image can be formed on the print medium PM, and the toned white image can be set to the desired color. In addition, in the second embodiment, since plural kinds of toned white images having different colors can be formed on the print medium PM, it is possible to prepare various printed matters.

### C. Third Embodiment

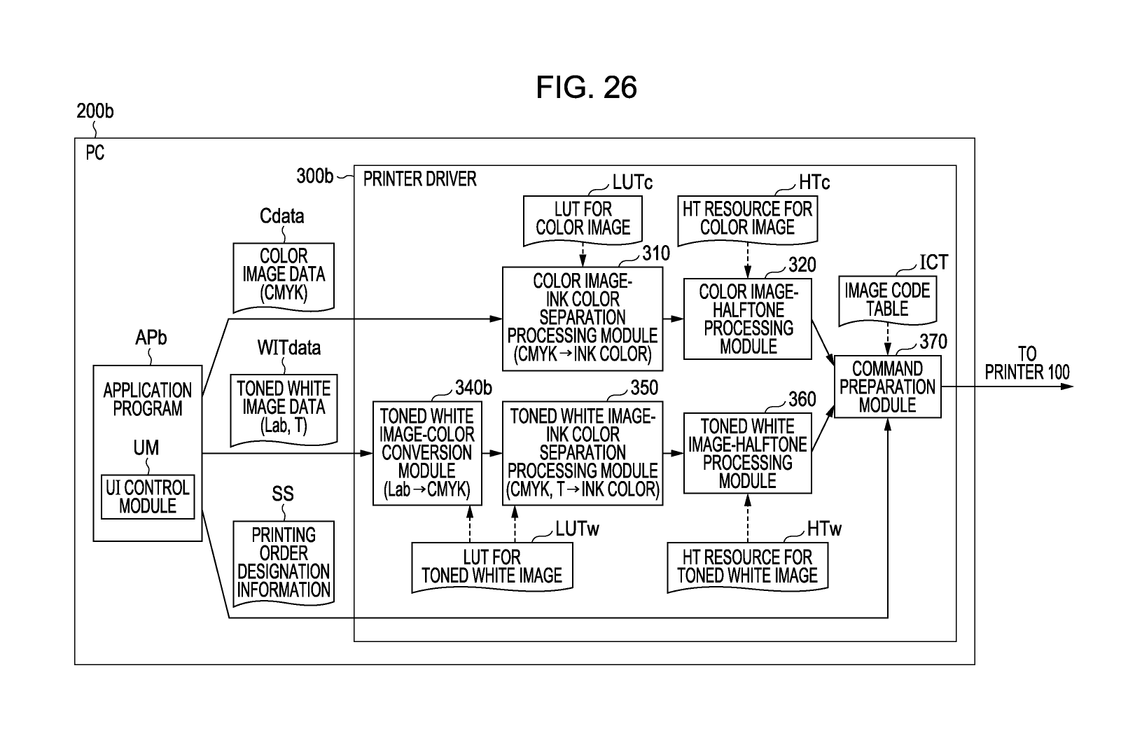

FIG. 26 is a block diagram functionally illustrating the configuration of a PC 200b according to the third embodiment. The PC 200b of the third embodiment is substantially similar to the PC 200 of the first embodiment shown in FIG. 4, except that an application program APb includes an UI control module UM and a printer driver 300b does not include the toned white designation module 330. That is, in the third embodiment, the toned white designation process (step S220 in FIG. 9) is performed not by the printer driver 300b, but by the application program APb. In the third embodiment, the content of the toned white designation process is identical to that of the toned white designation process in the first embodiment.

According to the printing process of the third embodiment, after the toned white designation process by the application program APb is executed, if the user instructs the printing execution, the color image data Cdata, the white image data WITdata, and the printing order designation information SS are output to the printer driver 300b, and the processing of the printer driver 300b is started. The contents of the color image data Cdata and the printing order designation information SS are identical to those in the first embodiment. The white image data WITdata is data corresponding to the Lab value and T value which are designated to the image data WIdata (data specifying the white region Aw (refer to FIG. 7) of the print image PI) in the first embodiment by the toned white designation process.

In the processing of the printer driver 300b, the toned white image-color conversion module 340b of the printer driver 300b receiving the toned white data WITdata color-converts the Lab value defined by the toned white image data WITdata into the CMYK value. The color conversion is executed similar to the first embodiment (step S230 in FIG. 9). The processing content after that is similar to the first embodiment (after step S240 in FIG. 9).

As described above, in the third embodiment, the color image and the toned white image can be formed on the print medium PM, and the toned white image can be set to the desired color.

### D. Fourth Embodiment

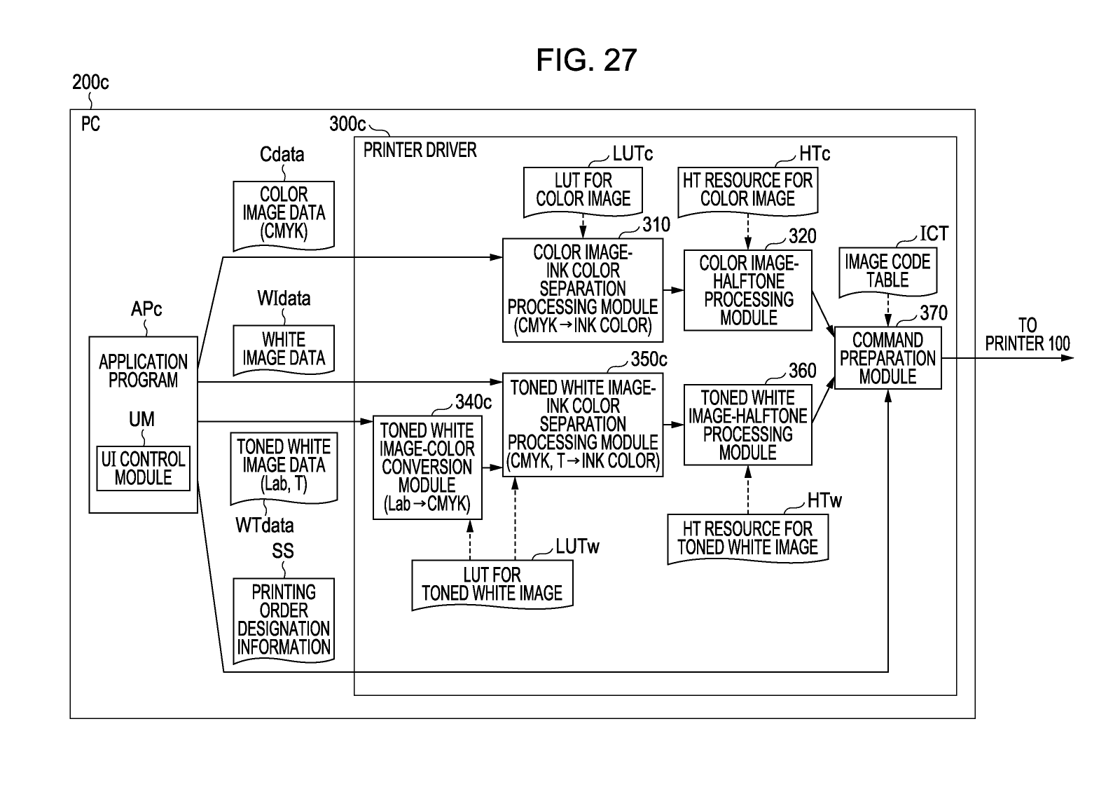

FIG. 27 is a block diagram functionally illustrating the configuration of a PC 200c according to the fourth embodiment. The PC 200c of the fourth embodiment is substantially similar to the PC of the third embodiment shown in FIG. 26, except for the data output from an application program APc to a printer driver 300c. That is, in the fourth embodiment, the white image data WIdata and the toned white data WTdata are output, instead of the toned white image data WITdata in the third embodiment. The content of the toned white data WIdata is identical to that of first embodiment. Further, the toned white data WTdata is data corresponding to the Lab value and T value designated by the toned white designation process by the UI control module UM of the application program APc.

In the printing process of the fourth embodiment, after the toned white designation process by the application program APc is executed, if the user instructs the printing execution, the color image data Cdata, the white image data WIdata, the toned white data WTdata, and the printing order designation information SS are output to the printer driver 300c, thereby starting the processing by the printer driver 300c.

According to the processing by the printer driver 300c, the toned white image-color conversion module 340c of the printer driver 300c receiving the toned white data WTdata color-converts the Lab value defined by the toned white image data WTdata into the CMYK value, and outputs the color-converted data to a toned white image-ink color separation processing module 350c. The color conversion is executed similar to the first embodiment (step S230 in FIG. 9). Further, the toned white image-ink color separation processing module 350c receives the white image data WIdata, and performs the ink color separation processing by using the color converted data and the white image data WIdata (step S230 in FIG. 9). The processing content after that is similar to the first embodiment (after step S240 in FIG. 9).

As described above, in the fourth embodiment, the color image and the toned white image can be formed on the print medium PM, and the toned white image can be set to the desired color.

### E. Fifth Embodiment

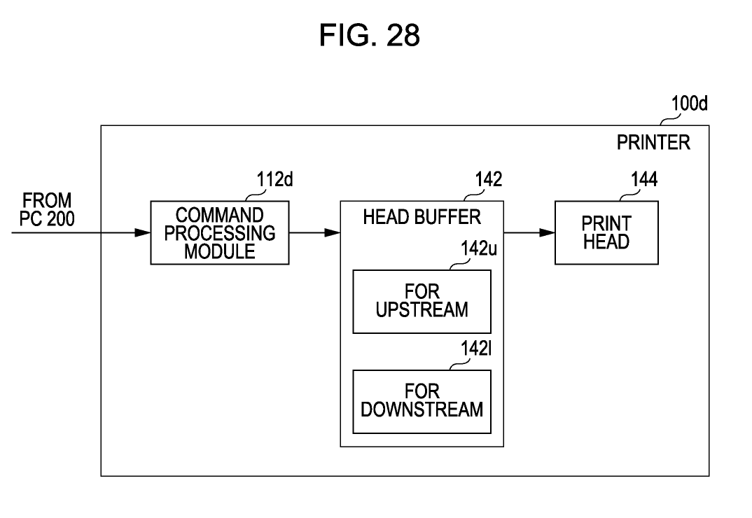

The fifth embodiment is similar to the first embodiment, except that the processing of converting the raster data (dot data) in a data transmission mode to the print head 144 is performed by the printer driver 300, in which the processing is executed by the printer 100 in the first embodiment. FIG. 28 is a block diagram functionally illustrating the configuration of a 100d printer according to the fifth embodiment. The printer 100d of the fifth embodiment is similar to the printer 100 of the first embodiment shown in FIG. 5, except that the printer 100d does not include the raster buffer 132. Also, other configuration of the printing system 10 (FIG. 1) of the fifth embodiment, namely the configuration of the PC 200, is similar to the first embodiment.

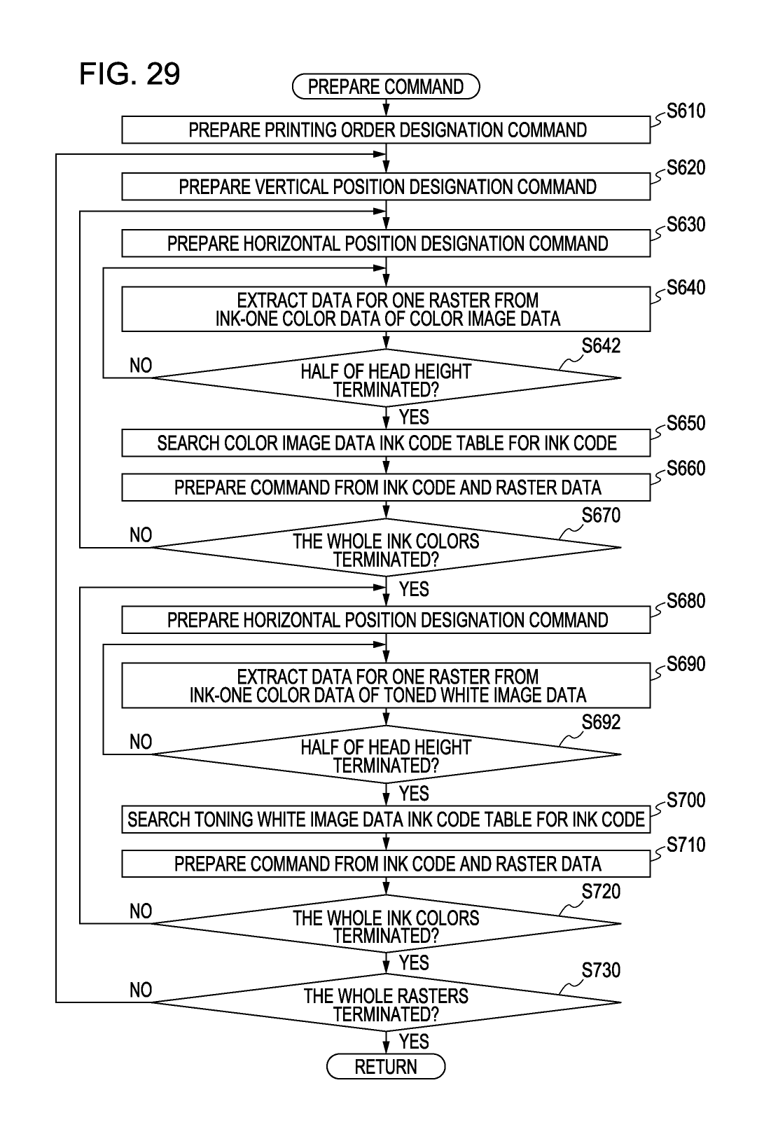

FIG. 29 is a flowchart illustrating the flow of a command preparation processing according to the fifth embodiment. In FIG. 29, steps having the like contents as those of the steps of the command preparation processing according to the first embodiment shown in FIG. 17 are denoted by the same step numerals. In the command preparation processing of the fifth embodiment, the processing (step S640) of extracting the dot data for one raster with respect to one ink color selected from the color image-dot data is repeatedly executed by the command preparation module 370 (FIG. 4) until the extraction of the data by ½ of the height of print head 144 is terminated (refer to step S642). Further, in step S640, the dot data of the raster corresponding to a nozzle pitch of the nozzle array 146 of the print head 144 is extracted. That is, in a case where the nozzle pitch and print resolution of a Y-direction are identical, the dot data of continuous rasters is sequentially extracted. In a case in which the nozzle pitch is two times of the print resolution of the Y-direction, the dot data of one raster skip is sequentially extracted.

If the extraction of the data of ½ of the height of the print head 144 is completed (Yes in step S642), the ink code is searched (step S650), and the raster command for the color image is prepared (step S660). That is, in the fifth embodiment, a raster command including raster data of ½ of the height of the print head 144 is prepared.

Similar to a raster command for the toned white image, a raster command including raster data of ½ of the height of the print head 144 is prepared (steps S690 and S692 in FIG. 29). If the command preparation processing is completed, the prepared command is transmitted to the printer 100d, similar to the first embodiment (step S260 in FIG. 9).

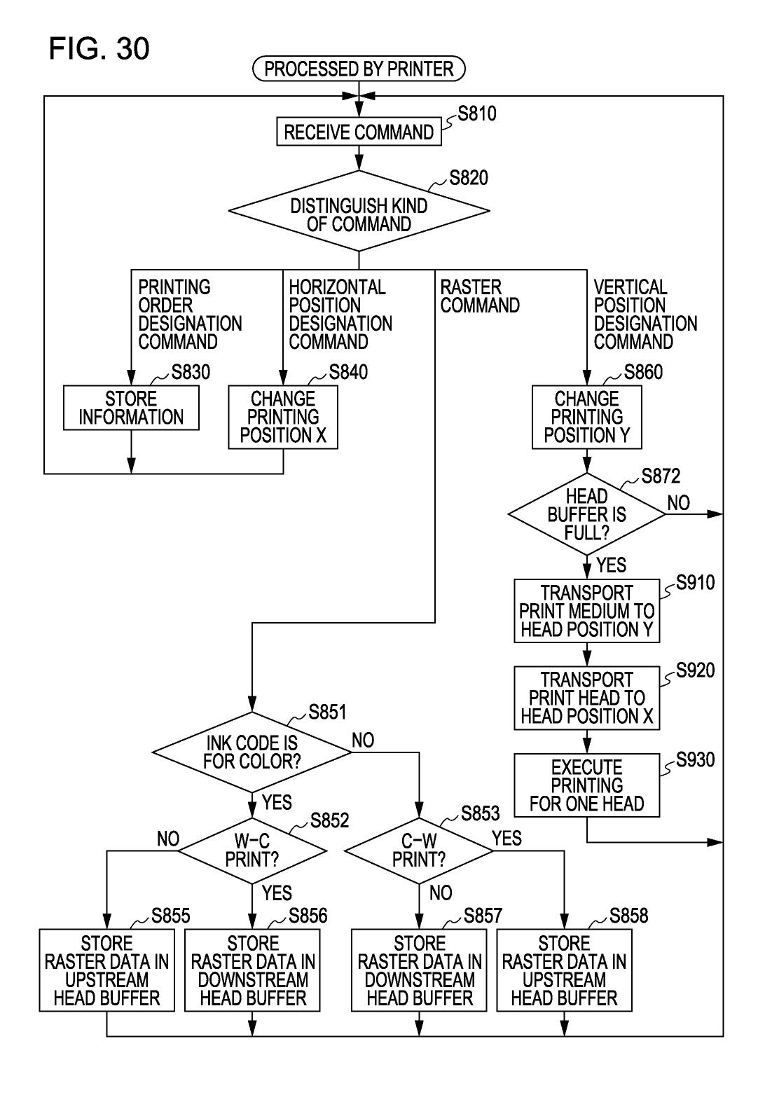

FIG. 30 is a flowchart illustrating the processing flow of the printer 100d according to the fifth embodiment. In FIG. 30, steps of the like content as that of the step of the processing by the printer according to the first embodiment shown in FIG. 20 are denoted by the common step numerals. According to the printer 100d of the fifth embodiment, the contents of a command reception processing (step S810 in FIG. 30), a process of discriminating the kind of the command (step S820), a processing in a case where it is judged that the command is the printing order designation command (step S830), and a processing in a case where it is judged that the command is the horizontal position designation command (step S840) are identical to those of the first embodiment.

In a case where it is judged that the command is the raster command, the ink code included in the raster command is for the color image (Yes in step S851). In a case where the printing order designated to the printing order designation command is the C-W printing (No in step S852), the raster data for the color image included in the raster command is stored in the upstream head buffer 142u (step S855). Meanwhile, in a case where the ink code is for the color image (Yes in step S851) and the printing order designated to the printing order designation command is the W-C printing (Yes in step S852), the raster data for the color image included in the raster command is stored in the downstream head buffer 142l (step S856).

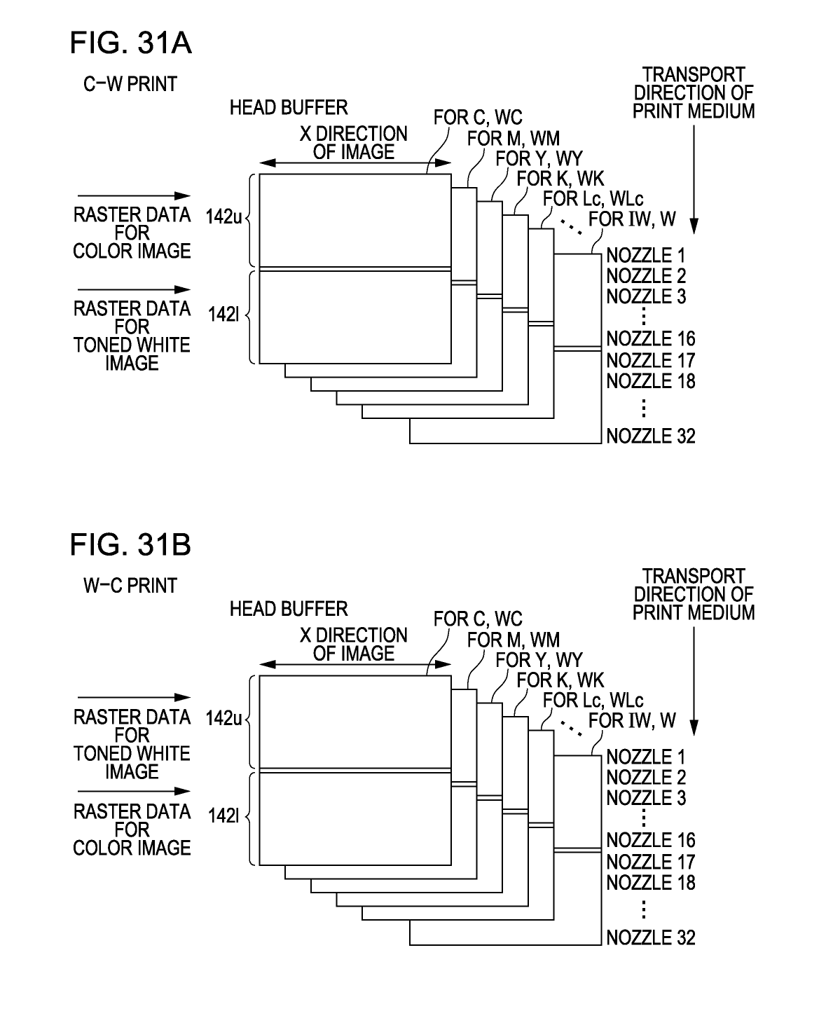

FIGS. 31A and 31B are diagrams illustrating a method of storing the raster data in the head buffer 142. FIG. 31A illustrates a method of storing the raster data at the time of the C-W printing. As shown in FIG. 31A, at the C-W printing, the raster data for the color image is stored in the upstream head buffer 142u, and at the W-C printing, the raster data for the color image is stored in the downstream head buffer 142l.

In a case where the ink code is for the toned white image (No in step S851) and the printing order designated to the printing order designation command is the C-W printing (No in step S853), the raster data for the toned white image included in the raster command is stored in the downstream head buffer 142l (step S857) (refer to FIG. 31A). Meanwhile, in a case where the ink code is for the toned white image (No in step S851) and the printing order designated to the printing order designation command is the W-C printing (Yes in step S853), the raster data for the toned white image included in the raster command is stored in the upstream head buffer 142u (step S858 (refer to FIG. 31B).

In a case where it is judged that the command is the vertical position designation command, the printing start position Y of the vertical direction is updated (step S860), and it is judged whether the head buffer 142 is full or not (i.e., raster data is stored or not) (step S872). In a case where it is judged that it is not yet full (No in step S872), the processing is returned to the command reception processing (step S810).

If it is judged that the head buffer 142 is full (Yes in step S872), the print medium PM is transported to the head position Y (the sub scanning is performed) (step S910), the print head 144 is moved to the printing start position X (step S920), and the main scanning is performed to execute the printing for height of the print head 144 (step S930).

As described above, in the fifth embodiment, the raster data is stored in the head buffer 142 based on the raster command output from the printer driver 300 and received by the printer 100d, and the printing is executed based on the raster data stored in the head buffer 142. In the fifth embodiment, the color image and the toned white image can be formed on the print medium PM, and the toned white image can be set to the desired color.

### F. Modified Example

The invention is not limited to the above-described embodiments or examples, and may be implemented in various aspects without departing from the scope of the invention. For example, the following modified examples may be provided.

### F1. Modified Example 1

In the respective embodiments, the configuration of the printing system 10 is illustrated as an example, and the configuration of the printing system 10 may be modified variously. For example, in each embodiment, the printer 100 is a printer capable of performing the printing by using 7 ink colors of cyan, magenta, yellow, black, light cyan, light magenta, and white color, but the printer 100 my be a printer capable of performing the printing the plurality of ink colors including the white color. For example, the printer 100 may be a printer capable of performing the printing by using 5 ink colors of cyan, magenta, yellow, black and white color.

Further, although 6 ink colors except for the white color are used in the formation of the color image and the white ink is not used in each embodiment, the ink color used to form the color image may be optionally selected depending upon the ink color usable in the printer 100. For example, the white ink may be used in the formation of the color image.

In addition, although 5 ink colors of white, yellow, black, light cyan and light magenta ink are used in the formation of the toned white image, and two ink colors of cyan and magenta colors are not used in each embodiment, the ink color used in the formation of the toned white image may include the white color and at least one color except for the white color, and may be optionally set depending upon the ink color usable in the printer 100. For example, in the formation of the toned white image, only 4 ink colors of white, yellow, light cyan and light magenta color may be used, or 7 ink colors of white, yellow, black, light cyan, light magenta, cyan and magenta color may be used.

Moreover, although the printer 100 is a printer capable of performing the printing by reciprocating (main scanning) the carriage on which the print head 144 is mounted in each embodiment, the invention may be applied to a printing process by a line printer in which the carriage does not reciprocate.

Further, although the printer driver 300 is provided in the PC 200 and the printer 100 receives the command from the printer driver 300 of the PC 200 to perform the printing (refer to FIG. 4), the printer 100 may include the same function as the printer driver 300 having the toned white designation module 330 or the UI control module 332, and receive the color image data Cdata, the white image data WIdata, and the printing order designation information SS from the application program AP of the PC 200 to perform the printing. Alternatively, the printer 100 may further include the same function as the application program AP, generate the color image data Cdata, the white image data WIdata, and the printing order designation information SS in the printer 100 to execute the printing process.

Further, in each embodiment, the content of the toned white image-lookup table LUTw (FIG. 14) or the color image-lookup table LUTc (FIG. 16) is illustrated as one example, and the content thereof may be experimentally set in advance, for example, depending upon the composition of the ink used in the printer 100. In addition, the content thereof may be modified in various depending upon the content (used color space) of the data output from the application program AP or the ink color used in the printer 100. Similarly, the content of the color conversion processing or the ink color separation processing using the table may be modified in various.

In addition, although the halftone processing with reference to the dither pattern is performed by the color image-halftone processing module 320 or the toned white image-halftone processing module 360 (FIG. 4) in each embodiment, a halftone processing using other method such as error diffusion method. Further, in a case where dots of plural sizes can be formed with respect to each ink color by the printer 100, the binarization determining ON/OFF of the dot is not performed by the halftone processing, but multinarization determining the ON/OFF of the dot and the dot size may be performed.

In each embodiment, the configuration of the printing order designation command or the raster command (FIG. 18) and the content of the ink code table ICT (FIG. 19) is illustrated as one example, and may be modified in various. Further, although the ink code corresponds constantly to each of plural ink colors and a combination of the color image and the toned white image in each embodiment, the ink code is not necessary to be set as the above. Whereby, if the ink code is set as the above, the CPU 110 of the printer 100 does not be aware of whether the raster command is the color image or the toned white image, and perform the processing of the command in accordance with the ink code contained in the raster command.

Further, in each embodiment, a part of the configuration which is implemented by the hardware may be substituted by software; on the contrary, a part of the configuration which is implemented by the software may be substituted by hardware.

In addition, in a case where a part or the whole of the function of the invention is implemented by the software, the software (computer program) may be provided in such a manner that it is stored in a computer-readable recording medium. In the invention, the ‘computer-readable recording medium’ is not limited to a portable recoding medium such as flexible disc or CD-ROM, and includes various internal storage devices, such as RAM or ROM, in a computer, or an external storage device, such as hard disc, fixed to the computer.

### F2. Modified Example 2

In each embodiment, although there is described the printing process of preparing the printed matter formed with the color image and the toned white image by forming the color image and the toned white image on a transparent film serving as the print medium PM in combination, the print medium PM used in the printing process is not limited to the transparent film, and can select optional medium such as translucent film, paper or fabric. In this instance, if the transparent film is used as the print medium PM, the color image Ic can be formed to be the appearance intact in the C-W printing (FIG. 8B).

Further, in each embodiment, the printer 100 can execute the printing process of forming only the color image (including the color image formed by using the white ink), and in this instance, the printing is performed by the whole nozzle arrays 146, without dividing the nozzle array 146 (refer to FIG. 22) of the print head 144 into the upstream side and the downstream side. That is, the printer 100 may perform the printing by dividing the nozzle array 146 into the nozzle group for forming the color image and the nozzle group for forming the toned white image only in a case of performing the printing process of forming the color image and the toned white image.

In addition, according to the printing process of each embodiment, although at least a portion of the toned white image is overlapped with the color image, the invention can be applied to the printing process in which the color image is not overlapped with the toned white image.

### F3. Modified Example 3

In each embodiment, the display content of the UI window W1 for the toned white image destination and the UI window W2 (FIG. 11) for the color measurement is illustrated as one example, and the displayed content may be modified in various. For example, in the UI window W1 for the toned white destination according to each embodiment, although the toned white is designated by the color coordination value the L*a*b* color coordinate system (color space), the toned white may be designated by other color coordination system (e.g., L*u*v* color coordinate system). Further, in the UI window W1 for the toned white destination of each embodiment, although the concentration of the toned white is designated by the T value, the designation of the T value may be omitted. In addition, in the UI window W1 for the toned white destination of each embodiment, although the toned white can be designated by the color measurement (refer to the UI window W2 for color measurement), it is not necessary to designate the toned white inevitably.

### F4. Modified Example 4

In each embodiment, although the print process of forming the color image and the toned white image on the print medium PM is described, the invention is not limited to the combination of the color image and the toned white image, and may be applied to a printing process of forming plural images corresponding to a plurality of ink groups of different color reproduction region on the recording medium PM in an overlapping manner. For example, if a combination (ink group) of 4 ink colors of cyan, magenta, yellow and black color and a combination (ink group) of 3 ink colors of yellow, light cyan and light magenta color are set from 7 ink colors used in the printer 100, the color reproduction region (gamut) of each ink group is different form each other. The printing system 10 of each embodiment can execute the printing process of forming two images having different color reproduction regions corresponding to two ink groups on the print medium PM in such a manner that they are overlapped with at least a portion thereof, similar to the printing process of forming the color image and the toned white image. In this instance, the invention is not limited to the case in which the number of ink groups is 2, and may be applied to a case in which the number of ink groups is 3. In a case in which the number of ink groups is 3 or more, the nozzle array 146 of the print head 144 is divided into 3 or more nozzle groups, and each nozzle group performs the printing of the image corresponding to each ink group.

### F5. Modified Example 5

According to the method of measuring the total optical transmittance in the white portion Pw of the real print RP in each embodiment, although the transmittance Tn (wavelength-based transmittance) is measured with respect to each wavelength at an interval of 1 nm, and the value obtained by integrating the transmittance Tn in the entire wavelength range of the visible light is determined as the total optical transmittance S, the method of measuring the total optical transmittance is not limited thereto, and may be modified in various. For example, the total optical transmittance S is not necessary to be the value obtained by integrating the transmittance Tn. That is, the total transmittance S may be the sum of the transmittance Tn with respect to a plurality of predetermined wavelengths, and the total optical transmittance S may be the sum of the transmittance Tn obtained in a case where the transmittance Tn is obtained from other interval than the interval of 1 nm. In addition, the total optical transmittance S may be calculated based on the transmittance Tn not in the entire wavelength range of the visible light, but in a partial wavelength range.

According to the method of measuring the total optical transmittance S in the white portion Pw of the real print RP in each embodiment, although the white substrate Bw and the black substrate Bb are used, the color used to measure the total optical transmittance S is not limited to the white color and the black color, and other color may be used. In addition, although the third method of measuring the total optical transmittance S calculates the total optical transmittance S by using a difference between two transmittance Tn calculated for two substrates, the total optical transmittance S may be calculated by using an average of two transmittance Tn. Further, the total optical transmittance S may be calculated by using a difference of three transmittance Tn calculated from three or more substrates (e.g., by using an average of three or more transmittance Tn).

Further, although there is described the method of measuring the total optical transmittance S in the white portion Pw of the real print RP in each embodiment, the invention is not limited to the white portion Pw of the real print RP, and can be commonly applied to the case of measuring the optical transmittance on the printed matter.

In addition, although the T value is calculated by converting (normalizing) the inverse number of the total optical transmittance S into a value in a range of 0 to 100 in each embodiment, it may be calculated by other conversion if the T value is calculated based on the total optical transmittance S. For example, the inverse number of the total optical transmittance S itself may be the T value.

Moreover, although the measurement of the total optical transmittance S in the white portion Pw of the real print RP is executed so as to calculate the T value specifying the toned white in each embodiment, the measurement of the total optical transmittance S may be executed for the other purpose. For example, the measurement of the total optical transmittance S may be executed for the color judgment of the real print RP. In this instance, for example, if the value of the total optical transmittance S is 2000 or less, the L value separately measured is 65 or more, and both absolute values of the a value and the b value are 20 or less, it may be judged that the color of the real print RP is a white color. The result of the color judgment (white color judgment) of the real print RP may be used, for example, so as to perform the judgment of necessity in nozzle check.

What is claimed is:

1. A printing method of performing printing on a printed matter by using a printing apparatus, comprising:
(a) obtaining from the printed matter a wavelength-based transmittance which is transmittance to plural visible light;
(b) determining optical transmittance of the printed matter based on the wavelength-based transmittance; and
(c) ejecting white ink onto the printed matter based on the optical transmittance.

2. The printing method according to claim 1, wherein the step (b) is a step of determining a value obtained by integrating the wavelength-based transmittance in a predetermined wavelength range.

3. The printing method according to claim 2, wherein the printed matter includes a print medium and an image of a white color, and the plural visible light are the entire wavelength range of visible light.

4. The printing method according to claim 3, wherein the step (a) is a step of measuring reflectance of a substrate having a predetermined optical transmittance, and a reflectance of the printed matter on the substrate, and determining the wavelength-based transmittance based on the optical transmittance and reflectance of the substrate, and the reflectance of the printed matter.

5. The printing method according to claim 4, wherein the step (a) is a step of determining a product of a square root of a ratio of the reflectance of the printed matter to the reflectance of the substrate, and the optical transmittance of the substrate as the wavelength-based transmittance.

6. The printing method according to claim 5, wherein the step (a) is a step of determining the wavelength-based transmittance of the plurality of substrates having different colors based on the optical transmittance and reflectance of the substrate, and the reflectance of the printed matter, and
the step (b) is a step of determining the optical transmittance of the printed matter based the wavelength-based transmittance of the plurality of substrates.

7. The printing method according to claim 6, wherein the step (a) is a step of determining the wavelength-based transmittance of two substrates having different colors based on the optical transmittance and reflectance of the substrate, and the reflectance of the printed matter, and
the step (b) is a step of determining the optical transmittance of the printed matter based a difference between the wavelength-based transmittances of two substrates.

8. The printing method according to claim 7, wherein the step (b) is a step of determining a value obtained by integrating the difference between the wavelength-based transmittances in the predetermined wavelength range as the optical transmittance of the printed matter.

9. The printing method according to claim 8, further comprising (c) determining whether a color of the printed matter is white or not, based on the determined optical transmittance of the printed matter.

10. A printing apparatus of performing printing on a printed matter, comprising:
(a) a unit of obtaining from the printed matter a wavelength-based transmittance which is transmittance to plural visible light;
(b) a unit of determining an optical transmittance of the printed matter based on the wavelength-based transmittance; and
(c) a unit of ejecting a white ink onto the printed matter based on the optical transmittance.
